(19) United States
(12) Patent Application Publication
(10) Pub. No.: US 2013/0246060 A1
(43) Pub. Date: Sep. 19, 2013

(54) SIGNAL PROCESSING DEVICE, SIGNAL PROCESSING METHOD AND SIGNAL PROCESSING PROGRAM

(71) Applicant: Akihiko Sugiyama, Tokyo (JP)

(72) Inventor: Akihiko Sugiyama, Tokyo (JP)

(73) Assignee: NEC CORPORATION, Tokyo (JP)

(21) Appl. No.: 13/989,689

(22) PCT Filed: Nov. 21, 2011
(86) PCT No.: PCT/JP2011/077285

§ 371 Date: May 24, 2013

(30) Foreign Application Priority Data
Nov. 25, 2010 (JP) 2010-263022

(51) Int. Cl. G10L 21/0208

(52) U.S. Cl. CPC G10L 21/0208
USPC 704/226

(57) ABSTRACT

The purpose of the present invention is to obtain a higher-quality output signal by performing noise suppression in view of a background sound. The signal processing device disclosed in the present application is provided with suppression means for performing suppression of a second signal by processing a mixed signal in which a first signal and said second signal are contained. Moreover the signal processing device is provided with background sound estimation means for estimating a background sound signal in said mixed signal. Additionally, the signal processing device is provided with restriction means for restricting said suppression of said second signal such that a suppression result outputted by said suppression means does not become smaller than said estimated background sound signal.

### TECHNICAL FIELD

The present invention relates to a signal processing technology for emphasizing the first signal by suppressing the second signal in a noisy speech signal.

### BACKGROUND ART

There are well known noise suppressing technologies, with respect to a noisy speech signal (a signal in which a second signal is superposed on a first signal), for suppressing the second signal contained in the noisy speech signal and outputting an emphasized signal (a signal resulting from emphasizing the first signal). A noise suppressor is a system for suppressing a noise superposed on a desired audio signal. Such a noise suppressor is used in various audio terminals, such as a mobile telephone.

With respect to this kind of technology, patent literature (PTL) 1 discloses a method of suppressing a noise by multiplying an input signal by spectral gains each having a value smaller than “1”. PTL 2 discloses a method of suppressing a noise by directly subtracting an estimated noise from a noisy speech signal.

### CITATION LIST

### Patent Literature

[PTL 1] Japanese Patent No. 4282227
[PTL 2] Japanese Patent Application Publication No. 1996-221092

### SUMMARY OF INVENTION

### Technical Problem

Nevertheless, there is a problem that, as the result of suppressing a noise using the method disclosed in PTL 1, sometimes, an output signal becomes smaller than a background sound, thereby making the output signal sound unnatural for listeners. This problem becomes further significant when a discontinuous or intermittent noise is removed. This is because, the output signals with and without noise suppression have a smaller and a larger power than that of the background signal, and thus, discontinuities at their boundaries are likely to be perceived.

In view of the above, an object of the present invention is to provide a signal processing technology which makes it possible to solve the aforementioned problem.

### Solution to Problem

To solve the aforementioned problem, a device of this invention comprises suppression means for performing suppression of a second signal by processing a mixed signal in which a first signal and said second signal are contained; background sound estimation means for estimating a background sound signal in said mixed signal; and restriction means for restricting said suppression of said second signal such that a suppression result outputted by said suppression means does not become smaller than said estimated background sound signal.

To solve the aforementioned problem, a method of this invention comprises receiving a mixed signal in which a first signal and a second signal are contained; estimating a background sound signal contained in said mixed signal; and performing suppression of said second signal along with restricting said suppression of said second signal such that an output does not become smaller than said estimated background sound signal.

To solve the aforementioned problem, a program of this invention causes a computer to execute processing which comprises an receiving step of receiving a mixed signal in which a first signal and a second signal are contained; a background sound estimation step of estimating a background sound signal contained in said mixed signal; and a suppression step of performing suppression of said second signal along with restricting said suppression of said second signal such that an output does not become smaller than said estimated background sound signal.

### Advantageous Effects of Invention

According to some aspects of the present invention, it is possible to obtain a higher-quality output signal by performing noise suppression in view of a background sound.

### BRIEF DESCRIPTION OF DRAWINGS

FIG. 1 is block diagram illustrating a configuration of a signal processing device according to a first exemplary embodiment of the present invention.

FIG. 2 is block diagram illustrating a configuration of a noise suppression device according to a second exemplary embodiment of the present invention.

FIG. 3 is block diagram illustrating configuration of transform unit according to a second exemplary embodiment of the present invention.

FIG. 4 is block diagram illustrating configuration of an inverse transform unit according to a second exemplary embodiment of the present invention.

FIG. 5 is a block diagram illustrating a configuration of a noise estimation unit according to a second exemplary embodiment of the present invention.

FIG. 6 is a block diagram illustrating a configuration of an estimated noise calculator according to a second exemplary embodiment of the present invention.

FIG. 7 is a block diagram illustrating a configuration of an update determination unit according to a second exemplary embodiment of the present invention.

FIG. 8 is a block diagram illustrating a configuration of a weighted noisy speech calculator according to a second exemplary embodiment of the present invention.

FIG. 9 is Fig. illustrating an example of a nonlinear function according to a second exemplary embodiment of the present invention.

FIG. 10 is a block diagram illustrating a configuration of a noise suppression device according to a third exemplary embodiment of the present invention.

FIG. 11 is a block diagram illustrating a configuration of a noise suppression device according to a fourth exemplary embodiment of the present invention.

FIG. 12 is a block diagram illustrating a configuration of a noise suppression device according to a fifth exemplary embodiment of the present invention.

FIG. 13 is a block diagram illustrating a configuration of a noise suppression device according to a sixth exemplary embodiment of the present invention.

FIG. 14 is a block diagram illustrating a configuration of a noise suppression device according to a seventh exemplary embodiment of the present invention.

FIG. 15 is a block diagram illustrating a configuration of a spectral gain generating unit according to a seventh exemplary embodiment of the present invention.

FIG. 16 is a block diagram illustrating a configuration of an estimated a-priori SNR calculator according to a seventh exemplary embodiment of the present invention.

FIG. 17 is a block diagram illustrating a configuration of a weighted adder according to a seventh exemplary embodiment of the present invention.

FIG. 18 is a block diagram illustrating a configuration of a spectral gain calculator according to a seventh exemplary embodiment of the present invention.

FIG. 19 is a block diagram illustrating a configuration of a noise suppression device according to an eighth exemplary embodiment of the present invention.

FIG. 20 is a block diagram illustrating a configuration of a noise suppression device according to a ninth exemplary embodiment of the present invention.

FIG. 21 is a block diagram illustrating a configuration of a noise suppression device according to a tenth exemplary embodiment of the present invention.

FIG. 22 is a block diagram illustrating a configuration of a noise suppression device according to an eleventh exemplary embodiment of the present invention.

FIG. 23 is a block diagram illustrating a configuration of a noise suppression device according to a twelfth exemplary embodiment of the present invention.

FIG. 24 is a block diagram illustrating a configuration of a noise suppression device according to a thirteenth exemplary embodiment of the present invention.

FIG. 25 is a block diagram illustrating a configuration of a noise suppression device according to a fourteenth exemplary embodiment of the present invention.

FIG. 26 is a block diagram illustrating a configuration of a noise suppression device according to a fifteenth exemplary embodiment of the present invention.

FIG. 27 is a block diagram illustrating a configuration of a noise suppression device according to a sixteenth exemplary embodiment of the present invention.

FIG. 28 is a block diagram illustrating a configuration of a noise suppression device according to a seventeenth exemplary embodiment of the present invention.

FIG. 29 is a block diagram illustrating a configuration of a noise suppression device according to an eighteenth exemplary embodiment of the present invention.

FIG. 30 is a block diagram illustrating a configuration of a noise suppression device according to a nineteenth exemplary embodiment of the present invention.

FIG. 31 is a block diagram illustrating a configuration of a noise suppression device according to another exemplary embodiment of the present invention.

### DESCRIPTION OF EMBODIMENTS

Hereinafter, exemplary embodiments of the present invention will be illustratively described with reference to the drawings. It is to be noted, however, that components described in the following exemplary embodiments are just exemplifications, and are not intended to restrict the technological scope of the present invention to only those components.

### First Exemplary Embodiment

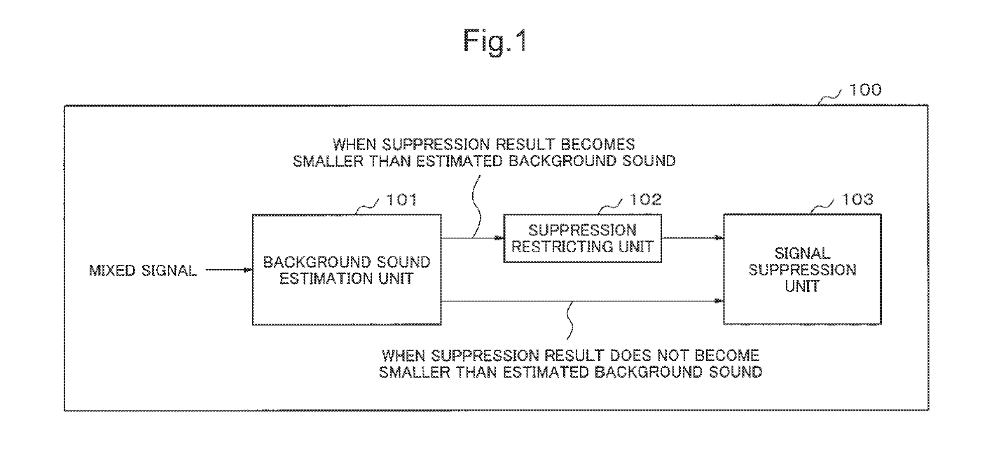

A signal processing device 100 as a first exemplary embodiment of the present invention will be described using FIG. 1.

The signal processing device 100 is a device for, by processing of a mixed signal in which a first signal and a second signal are mixed in, suppressing the second signal.

As shown in FIG. 1, the signal processing device 100 includes a background sound estimation unit 101, a suppression restricting unit 102 and a signal suppression unit 103. The background sound estimation unit 101 estimates a background sound signal contained in the mixed signal. The suppression restricting unit 102 restricts the suppression of the second signal such that the suppression result does not become smaller than that of the background sound signal. The signal suppression unit 103 suppresses the second signal by processing the mixed signal.

In such a configuration as described above, the signal processing device 100 can perform signal processing with higher quality leaving a background sound signal as it is.

### Second Exemplary Embodiment

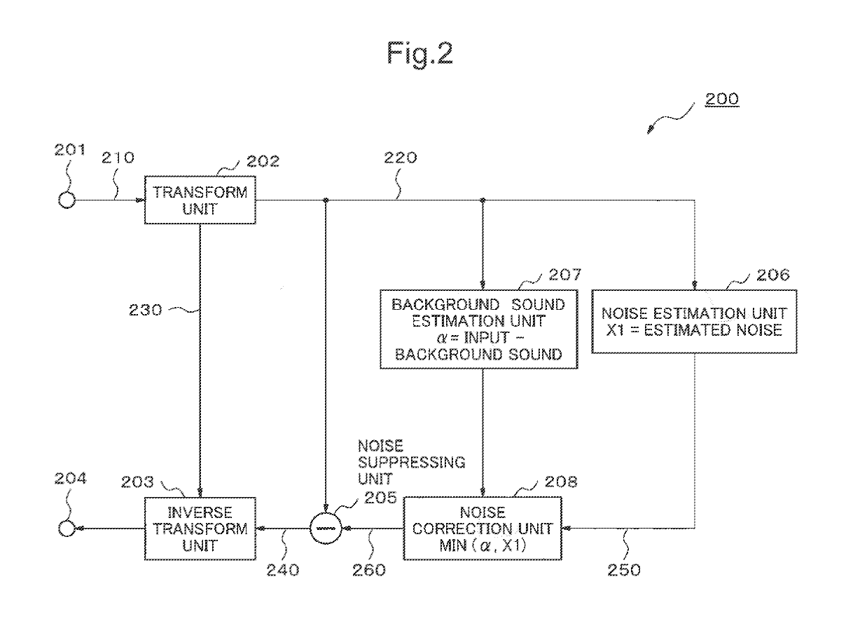

A noise suppression device as a second exemplary embodiment of the present invention will be described using FIGS. 2 to 11. The noise suppression device 200 of this exemplary embodiment also functions as part of a device, such as a digital camera, a laptop computer and a mobile telephone. Nevertheless, the present invention is not limited to this type of device, but can be applied to any kind of signal processing device for which noise removal from an input signal is required.

### <Entire Configuration>

FIG. 2 is block diagram illustrating the entire configuration of the noise suppression device 200. As shown in FIG. 2, the noise suppression device 200 includes, an input terminal 201, a transform unit 202, an inverse transform unit 203, an output terminal 204, a noise suppression unit 205, a noise estimation unit 206, a background sound estimation unit 207 and a noise correction unit 208. A noisy speech signal (a mixed signal in which a desired signal as a first signal and a noise as a second signal are mixed in) is supplied to the input terminal 201 as a sequence of sample values. The noisy speech signal, which is supplied to the input terminal 201, is subjected to transformation, such as Fourier transform, and is decomposed into a plurality of frequency components in the transform unit 202. Each of the plurality of frequency components is independently processed. Here, description will be continued focusing on a specific frequency component. An amplitude spectrum of the specific frequency component, that is a noisy speech signal amplitude spectrum 220, is supplied to the noise suppression unit 205, and a phase spectrum thereof, that is a noisy speech signal phase spectrum 230, is supplied to the inverse transform unit 203. Here, although the noisy speech signal amplitude spectrum 220 is supplied to the noise suppression unit 205, the present invention is not limited to this configuration, but a power spectrum, which is equivalent to the square thereof, may be supplied to the noise suppression unit 205.

The noise estimation unit 206 estimates noise by using the noisy speech signal amplitude spectrum 220 supplied from the transform unit 202, and generates noise information 250 (estimated noise) as an example of an estimated second signal. Further, the background sound estimation unit 207 estimates the background sound by using the noisy speech signal amplitude spectrum 220 supplied from the transform unit 202, and supplies a value α resulting from subtracting the background sound from the inputted noisy speech signal amplitude spectrum 220 to the noise correction unit 208. Further, the noise correction unit 208 selects a smaller one of the value α and noise information X1 for each frequency, and supplies it to the noise suppression unit 205. The noise correction unit 208 performs adjustment such that the noise information does not exceed the value α (here, α=input−background sound). That is, the noise correction unit 208 makes a suppression degree of the noise temperate so that the noise suppression result does not become smaller than the background sound. Specifically, the noise correction unit 208 supplies the value α to the noise suppression unit 205 in the case where the value α is smaller than the noise information X1, and supplies the noise information X1 to the noise suppression unit 205 in the case where the value α is larger than the noise information X1.

The background sound estimation unit 207 iteratively estimates the background sound and updates an estimated background sound. The background sound estimation unit 207 can obtain the estimated background sound by averaging the amplitudes of the noisy speech signal. As a technique for the averaging, the background sound estimation unit 207 employs a method using a sliding window based on a finite sample size or a method using leaky integration. The former one is known as an arithmetic operation of a finite impulse response filter in the field of signal processing. The number of the taps of the filter corresponds to the length of the sliding window. When denoting the finite sample size as L, the background sound estimation unit 207 can obtain a mean value by using the following equation (1):

$${\overline{x}}_{k}^{2} = \frac{1}{L} {\sum }_{j = k - L + 1}^{k} {x}_{j}^{2} . \qquad ( 1 )$$

When using the leaky integration, the background sound estimation unit 207 uses, for example, a first order leaky integration such as an equation (2) described below:

x̅ₖ²β· x̅ₖ₋₁²+(1−β)·xₖ² (2)

Here, β is a constant number which satisfies: 0<β<1.

The background sound estimation unit 207 can estimate the background sound only when the amplitude of the noisy speech signal is close to the background sound estimation, that is, when a ratio of the both values or a difference between the both values falls within a range between predetermined values. The background sound estimation unit 207 can calculate an initial value of the background sound estimation as a mean value of amplitude of the noisy speech signal. After having obtained the initial value, the background sound estimation unit 207 uses only noisy speech signals, each having amplitude close to the background sound estimation, for an averaging operation.

Noise information 260 resulting from the correction is supplied to the noise suppression unit 205, and there, is subtracted from the noisy speech signal amplitude spectrum 220 to output an emphasized signal amplitude spectrum 240, which is supplied to the inverse transform unit 203. The inverse transform unit 203 synthesizes the noisy speech signal phase spectrum 230, which is supplied from the transform unit 202, and the emphasized signal amplitude spectrum 240 and inverse transforms the result to output an emphasized signal, which is supplied to the output terminal 204.

### <Configuration of Transform Unit>

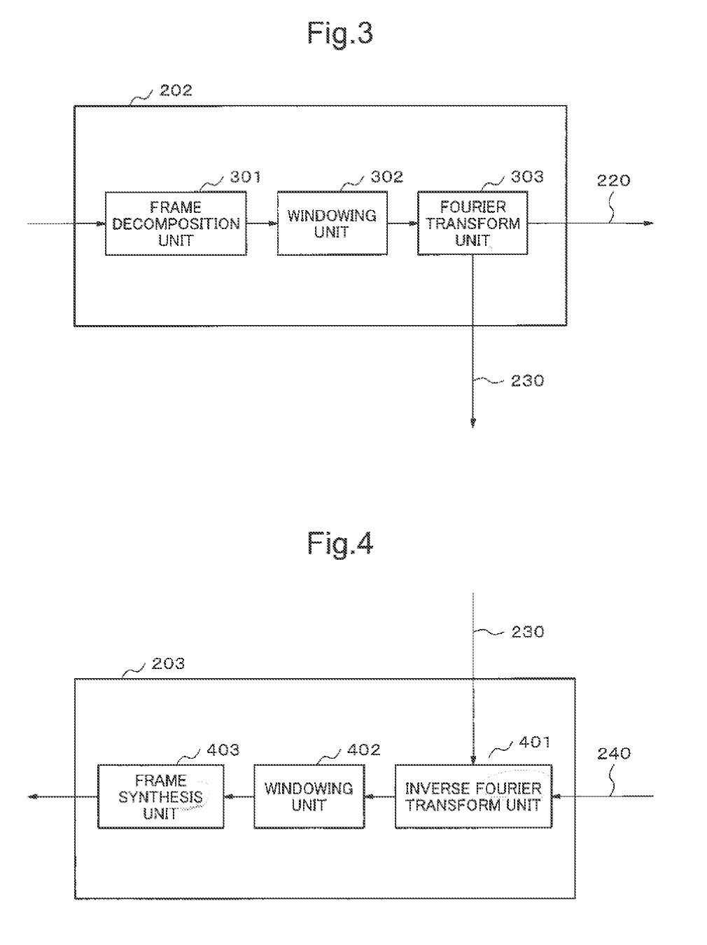

FIG. 3 is a block diagram illustrating a configuration of the transform unit 202. As shown in FIG. 3, the transform unit 202 includes a frame decomposition unit 301, a windowing unit 302 and a Fourier transform unit 303. Noisy speech signal samples are supplied to the frame decomposition unit 301, and there, they are decomposed into frames each having K/2 samples. Here, K is an even number. The noisy speech signal samples which are decomposed into frames are supplied to the windowing unit 302, and there, they are multiplied by w(t), which is a window function. A signal resulting from the windowing with the input signal in an n-th frame, yn(t) (t=0, 1, . . . , K/2−1) and w(t) is given by the following equation (3):

y̅ₙ=w(t)yₙ(t) (3)

Further, the windowing unit 302 may partially overlap every two successive frames with each other and then perform the windowing. Assuming that an overlap length is 50% of a frame length, the left-hand side portion of the following equation (4) represents the output of the windowing unit 302 at t=0, 1 . . . , K/2−1.

$$\begin{matrix}{\overline{y}}_{n} ( t ) = w ( t ) {y}_{n - 1} ( t + K / 2 ) \\ {\overline{y}}_{n} ( t + K / 2 ) = w ( t + K / 2 ) {y}_{n} ( t )\end{matrix} \} \qquad ( 4 )$$

With respect to a real number signal, the windowing unit 302 may use a symmetrical window function. Further, the window function is designed such that the input signal and the output signal match except for a computation error when a spectral gain is set to 1 in MMSE STSA method, or zero is subtracted in SS method. This means that an equation: w(t)+w(t+K/2)=1 is satisfied.

Hereinafter, description will be continued by way of an example in which windowing is performed such that every two successive frames are overlapped in 50% of a frame length.

For example, the windowing unit 302 may use, as w(t), a Hanning window which is represented by the following equation (5).

$$w ( t ) = \{ \begin{matrix}0.5 + 0.5 cos ( \frac{π ( t - K / 2 )}{K / 2} ) , & 0 \leq t < K \\ 0 , & otherwise\end{matrix} \qquad ( 5 )$$

Other various window functions, such as a Hamming window, a Kaiser window and a Blackman window, are also well known. An output obtained from the windowing is supplied to the Fourier transform unit 303, and there, is transformed into a noisy speech signal spectrum Yn (k). The noisy speech signal spectrum Yn (k) is separated into a phase and an amplitude, so that a noisy speech signal phase spectrum arg Yn (k) is supplied to the inverse transform unit 203 and a noisy speech signal amplitude spectrum |Yn (k)| is supplied to the noise estimation unit 206. As already described, a power spectrum may be used as a substitute for the amplitude spectrum.

### <Configuration of Inverse Transform Unit>

FIG. 4 is a block diagram illustrating a configuration of the inverse transform unit 203. As shown in FIG. 4, the inverse transform unit 203 includes an inverse Fourier transform unit 401, a windowing unit 402 and a frame synthesis unit 403. The inverse Fourier transform unit 401 multiplies the emphasized signal amplitude spectrum 240, which is supplied from the noise suppression unit 205, by the noisy speech signal phase spectrum 230 supplied from the transform unit 202, and thereby obtains an emphasized signal (the left-hand side portion of the following equation (6)).

X̅ₙ(k)=|Xₙ(k)|·arg Yₙ(k) (6)

The inverse Fourier transform unit 401 performs an inverse Fourier transform on the obtained emphasized signal, and supplies the windowing unit 402 with a sequence of time-domain sample values: xn(t) (t=0, 1, . . . , K−1), including K samples per one frame. The windowing unit 402 multiplies xn(t) by a window function w(t). A signal obtained by performing the windowing with an n-th frame input signal xn(t) (t=0, 1, . . . , K/2−1) and w(t) is given by the left-hand side portion of the following equation (7).

x̅ₙ(t)=w(t)xₙ(t) (7)

It is also widely carried out that two successive frames are partially overlapped with each other, and are windowed. Assuming that 50% of a frame length is an overlap length, the left-hand side portions of the following equations (8) correspond to an output of the windowing unit 402 at t=0, 1, . . . , K/2−1, which is transmitted to the frame synthesis unit 403.

$$\begin{matrix}{\overline{x}}_{n} ( t ) = w ( t ) {x}_{n - 1} ( t + K / 2 ) \\ {\overline{x}}_{n} ( t + K / 2 ) = w ( t + K / 2 ) {x}_{n} ( t )\end{matrix} \} \qquad ( 8 )$$

The frame synthesis unit 403 takes out two sets of K/2 samples from respective two adjacent frames among the output of the windowing unit 402, and overlaps the two sets of K/2 samples, and obtains an output signal at t=0, 1, . . . , K−1 (the left-hand side portion of the following equation (9)). The obtained output signal is transmitted to the output terminal 204 from the frame synthesis unit 403.

\hat{x}ₙ(t)= x̅ₙ₋₁(t+K/2)+ x̅ₙ(t) (9)

In FIGS. 3 and 4, transformation performed in each of the transform unit 202 and the inverse transform unit 203 was described as Fourier transform, but different transformation, such as a cosine transform, a modified cosine transform, Hadamard transform, Haar transform, wavelet transform, may be used as a substitute for the Fourier transform. For example, the cosine transform and the modified cosine transform each output only amplitudes as the transform result. Thus, in FIG. 2, a path from the transform unit 202 to the inverse transform unit 203 becomes unnecessary. In the case where each of the transform unit 202 and the inverse transform unit 203 uses the Haar transform, the multiplication becomes unnecessary. Thus, when each of the transform unit 202 and the inverse transform unit 203 is integrated into an LSI, an area occupied thereby can be made smaller. In the case where each of the transform unit 202 and the inverse transform unit 203 uses the wavelet transform, it is possible to expect the improvement of a noise suppression effect. That is because time resolutions can be changed to mutually different ones for respective frequencies.

### <Configuration of Noise Estimation Unit>

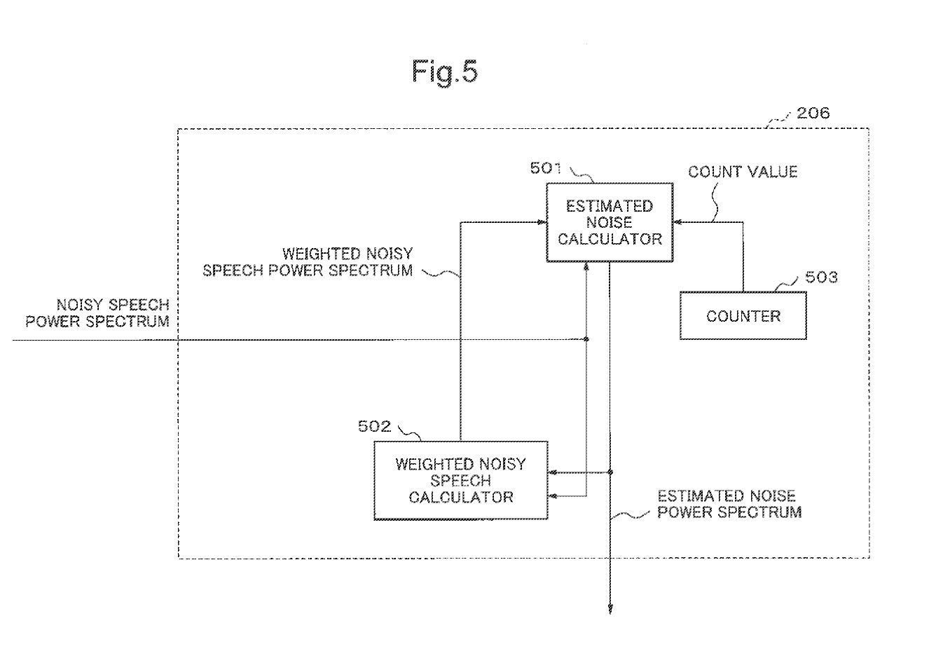

FIG. 5 is a block diagram illustrating a configuration of the noise estimation unit 206 of FIG. 2. The noise estimation unit 206 includes an estimated noise calculator 501, a weighted noisy speech calculator 502 and a counter 503. A noisy speech power spectrum supplied to the noise estimation unit 206 is transmitted to the estimated noise calculator 501 and the weighted noisy speech calculator 502. The weighted noisy speech calculator 502 calculates a weighted noisy speech power spectrum by using the supplied noisy speech power spectrum and an estimated noise power spectrum, and transmits the calculated weighted noisy speech power spectrum to the estimated noise calculator 501. The estimated noise calculator 501 estimates a power spectrum of noise by using the noisy speech power spectrum, the weighted noisy speech power spectrum and a count value supplied from the counter 503, outputs the estimated noise power spectrum, and further, feeds back it to the weighted noisy speech calculator 502.

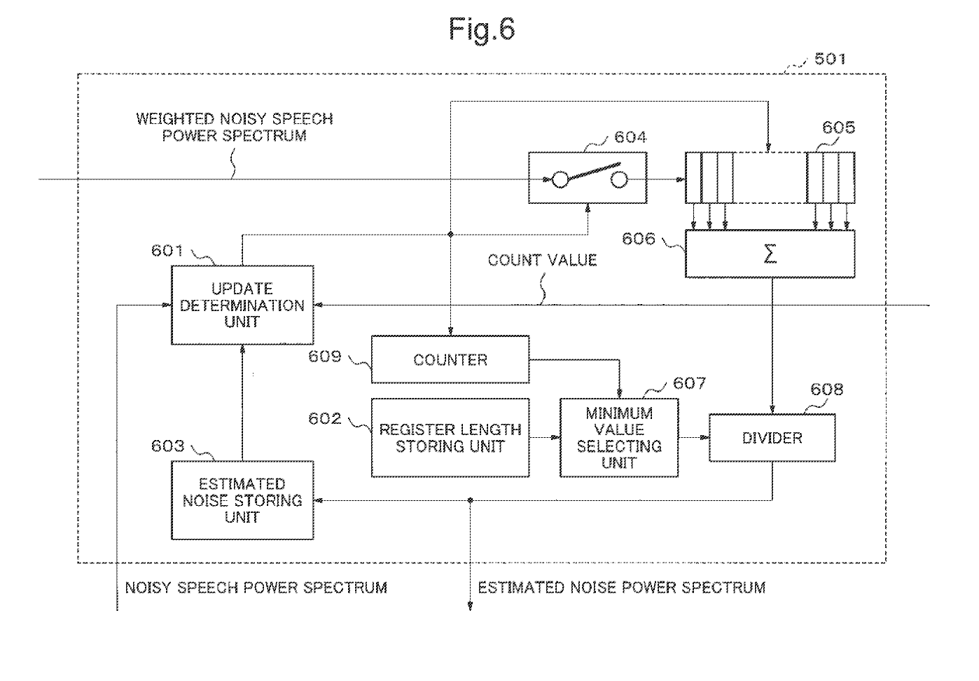

FIG. 6 is a block diagram illustrating a configuration of the estimated noise calculator 501 in FIG. 5. The estimated noise calculator 501 has an update determination unit 601, a register length storing unit 602, an estimated noise storing unit 603, a switch 604, a shift register 605, an adder 606, a minimum value selecting unit 607, a divider 608 and a counter 609. The switch 604 is supplied with the weighted noisy speech power spectrum. When the switch 604 closes its circuit, the weighted noisy speech power spectrum is transmitted to the shift register 605. The shift register 605 shifts the value which its each internal register stores to an adjacent internal register in response to a control signal supplied from the update determination unit 601. A shift register length is equal to a value which is stored in the register length storing unit 602 described below. All register outputs of the shift register 605 are supplied to the adder 606. The adder 606 performs addition of the supplied all register outputs, and transmits an addition result to the divider 608.

Meanwhile, the update determination unit 601 is supplied with a count value, a frequency-dependent noisy speech power spectrum and a frequency-dependent estimated noise power spectrum. The update determination unit 601 constantly outputs a value signal “1” until the count value reaches a preset value. After the count value has reached the preset value, the update determination unit 601 outputs a value signal “1” in the case where an inputted noisy speech signal is determined as noise; otherwise, the update determination unit 601 outputs a value signal “0”. Further, the update determination unit 601 transmits the outputted value signal to the counter 609, the switch 604 and the shift register 605. The switch 604 closes its circuit when a value signal supplied from the update determination unit is “1”, and opens its circuit when the value signal supplied therefrom is “0”. The counter 609 increments its count value when a value signal supplied from the update determination unit is “1”, and does not change its count value when the value signal supplied therefrom is “0”. When a value signal supplied from the update determination unit is “1”, the shift register 605 takes in one signal sample supplied from the switch 604, and at the same time, shifts the value which each of its internal registers stores to the internal register adjacent thereto. The minimum value selecting unit 607 is supplied with the output of the counter 609 and the output of the register length storing unit 602.

The minimum value selecting unit 607 selects a smaller one of the supplied count value and the register length, and transmits the selected count value or register length to the divider 608. The divider 608 performs division of the addition result value of the noisy speech power spectrum, having been supplied from the adder 606, by the smaller one of the count value and the register length, and outputs its quotient as the frequency-dependent estimated noise power spectrum λn(k). Supposing that Bn(k) (n=0, 1, . . . , N−1) are respective sample values of the noisy speech power spectrum stored in the shift register 605, the λn(k) is given by the following equation (10):

$${λ}_{n} ( k ) = \frac{1}{N} {\sum }_{n = 0}^{N - 1} {B}_{n} ( k ) \qquad ( 10 )$$

Here, N is a value of a smaller one of the count value and the register length. Since the count value starts from zero and increments monotonously, the divider 608 initially performs division of the addition result value by the count value, and then performs division thereof by the register length. When performing the division by the register length the divider 608 calculates an average value of the values stored in the shift register. Initially, sufficiently many values are not yet stored in the shift register 605, so the divider 608 performs division of the addition result value by the number of register elements in which values are actually stored. The number of register elements in which the values are actually stored is equal to the count value when the count value is smaller than the register length, and is equal to the register length when the count value becomes larger than the register length.

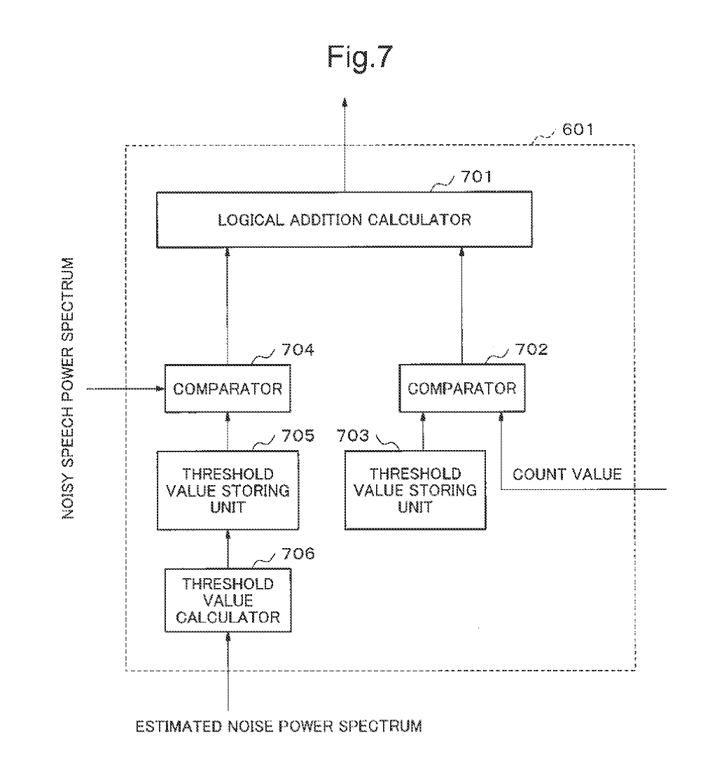

FIG. 7 is a block diagram illustrating a configuration of the update determination unit 601 in FIG. 6. The update determination unit 601 includes a logical addition calculator 701, comparators 702 and 704, threshold value storing units 705 and 703 and a threshold value calculator 706. The count value supplied from the counter 503 shown in FIG. 5 is transmitted to the comparator 702. A threshold value, which is the output of the threshold value storing unit 703, is also transmitted to the comparator 702. The comparator 702 compares the supplied count value and the threshold value, so that the comparator 702 transmits “1” to the logical addition calculator 701 in the case where the count value is smaller than the threshold value, and transmits “0” thereto in the case where the count value is larger than the threshold value. Meanwhile, the threshold value calculator 706 calculates a value in accordance with the estimated noise power spectrum supplied from the estimated noise storing unit 603 shown in FIG. 6, and outputs the calculated value to the threshold value storing unit 705 as a threshold value. The easiest method of calculating the threshold value is multiplying the estimated noise power spectrum by a constant number.

The threshold value calculator 706 may calculate the threshold value by using a polynomial of higher degree or a nonlinear function. The threshold value storing unit 705 stores therein a threshold value outputted from the threshold value calculator 706, and outputs a threshold value, which is stored while processing the last frame, to the comparator 704. The comparator 704 compares the threshold value supplied from the threshold value storing unit 705 and the noisy speech power spectrum supplied from the transform unit 202, and outputs “1” to the logical addition calculator 701 when the noisy speech power spectrum is smaller than the threshold value and outputs “0” thereto when the noisy speech power spectrum is larger than the threshold value. That is, the comparator 704 determines whether the noisy speech signal is noise, or not, on the basis of the estimated noise power spectrum. The logical addition calculator 701 calculates a logical sum of the output value of the comparator 702 and the output value of the comparator 704, and outputs the calculation result to the switch 604, the shift register 605 and the counter 609 which are shown in FIG. 6. In this way, the update determination unit 601 outputs “1” not only during an initial state and a silent period, but also when the noisy speech power is small even during a non-silent period. Thus, the update of estimated noise is performed. Since the threshold value is calculated for each frequency, it is possible to update the estimated noise for each frequency.

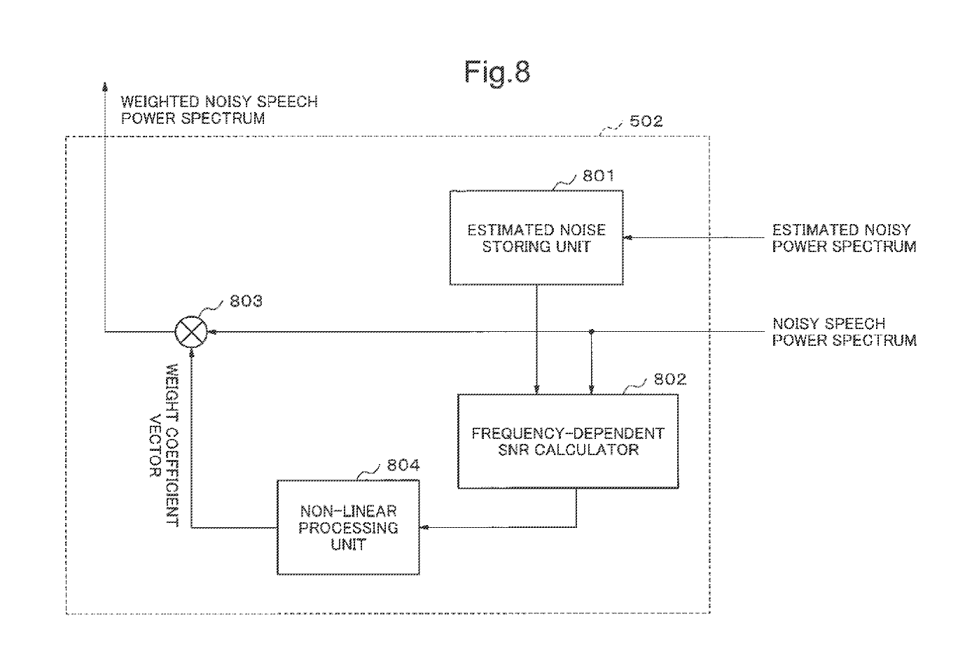

FIG. 8 is a block diagram illustrating a configuration of the weighted noisy speech calculator 502. The weighted noisy speech calculator 502 includes an estimated noise storing unit 801, a frequency-dependent SNR calculator 802, a non-linear processing unit 804 and a multiplier 803. The estimated noise storing unit 801 stores therein the estimated noise power spectrum supplied from the estimated noise calculator 501 shown in FIG. 5, and outputs the estimated noise power spectrum, which is stored while processing the last frame, to the frequency-dependent SNR calculator 802. The frequency-dependent SNR calculator 802 calculates a signal-noise ratio (SNR) for each frequency band by using the estimated noise power spectrum supplied from the estimated noise storing unit 801 and the noisy speech power spectrum supplied from the transform unit 202, and outputs the calculated SNR to the non-linear processing unit 804. Specifically, the frequency-dependent SNR calculator 802 calculates a frequency-dependent SNR γn(k) hat by performing division of the supplied noisy speech power spectrum by the supplied estimated noise power spectrum according to the following equation (11). Here, λn−1(k) is an estimated noise power spectrum, which is stored while processing the last frame.

$${\hat{γ}}_{n} ( k ) = \frac{{\vert {Y}_{n} ( k ) \vert}^{2}}{{λ}_{n - 1} ( k )} \qquad ( 11 )$$

The non-linear processing unit 804 calculates a weight coefficient vector by using the SNR supplied from the frequency-dependent SNR calculator 802, and outputs the calculated weight coefficient vector to the multiplier 803. The multiplier 803 calculates, for each frequency band, a product of the noisy speech power spectrum supplied from the transform unit 202 and the weight coefficient vector supplied from the non-linear processing unit 804, and outputs a weighted noisy speech power spectrum to the estimated noise calculator 501 shown in FIG. 5.

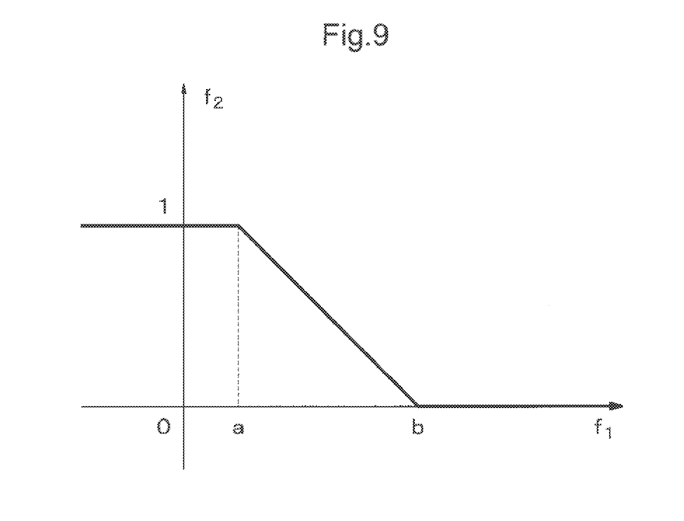

The non-linear processing unit 804 functions as a nonlinear function which outputs real number values in accordance with respective multiplexed input values. In FIG. 9, an example of the nonlinear function is illustrated. When supposing f1 as an input value, an output value f2 of the nonlinear function shown in the FIG. 9 is represented by the following equation (12). Here, a and b are predetermined real numbers, respectively.

$${f}_{2} = \{ \begin{matrix}1 , & {f}_{1} \leq a \\ \frac{{f}_{1} - b}{a - b} , & a < {f}_{1} \leq b \\ 0 , & b < {f}_{1}\end{matrix} \qquad ( 12 )$$

The non-linear processing unit 804 transforms a frequency-dependent SNR supplied from the frequency-dependent SNR calculator 802 into a weighting coefficient by using the nonlinear function, and transmits the weighting coefficient to the multiplier 803. That is, the non-linear processing unit 804 outputs a weighting coefficient which takes a value from “1” to “0” depending on the SNR. The non-linear processing unit 804 outputs “1” when the SNR is smaller than or equal to a, and outputs “0” when the SNR is larger than b.

The weighting coefficient, by which the noisy speech power spectrum is multiplied in the multiplier 803 shown in FIG. 8, is a value depending on the SNR, and the larger the SNR becomes, that is, the larger the amount of speech component included in the noisy speech becomes, the smaller the value of the weighting coefficient becomes. In general, the noisy speech power spectrum is used for the update of the estimated noise. In this exemplary embodiment, however, the multiplier 803 performs weighting the noisy speech power spectrum used for the update of the estimated noise depending on the SNR. In this way, the noise, suppression device 200 can make the influence of the speech component included in the noisy speech power spectrum smaller, thereby enabling more accurate estimation of noise. In the above example, the weighted noisy speech calculator 502 calculates the weighting coefficient by using a nonlinear function, but, may perform the calculation by using a function other than the nonlinear function, which represents the function of SNR in a different form, such as a linear function or a polynomial of higher degree.

In such a way as described above, according to the configuration of this exemplary embodiment, the noise suppression device 200 can realize signal processing with high quality, which does not make its output signal smaller than a background sound, and does not cause the discontinuity of its output signal to be perceived.

### Third Exemplary Embodiment

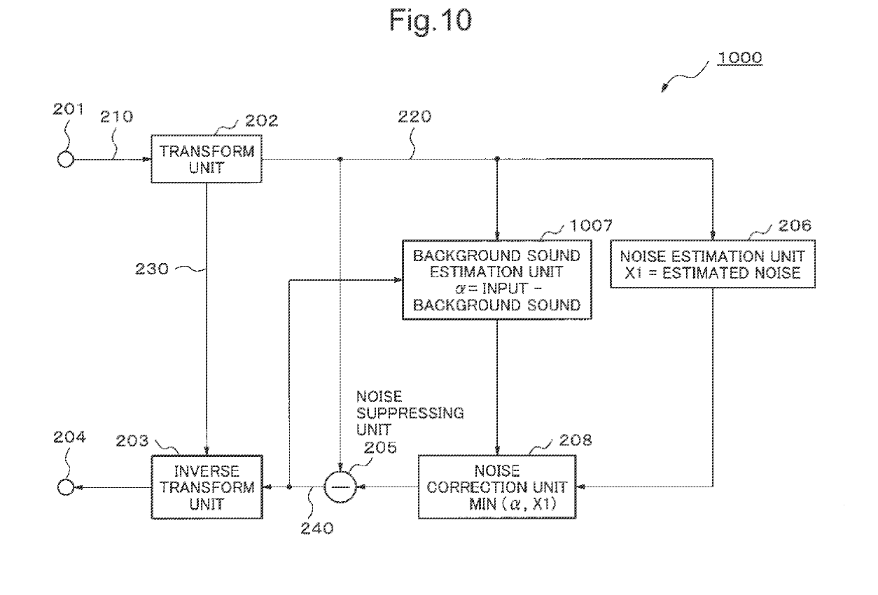

FIG. 10 is a block diagram illustrating a schematic configuration of a noise suppression device 1000 as a third exemplary embodiment of the present invention. The noise suppression device 1000 according to this exemplary embodiment is configured such that, unlike in the case of the second exemplary embodiment, the output of the noise suppression unit 205 is fed back to a background sound estimation unit 1007.

The background sound estimation unit 1007 determines the necessity or unnecessity of the estimation of the background sound in accordance with the presence or absence of a desired signal. That is, the background sound estimation unit 1007 updates background sound information only when no desired signal exists. Operation of the background sound estimation unit 1007 except for this operation is the same as that is described in the background sound estimation of the second exemplary embodiment, and thus, detailed description thereof is omitted here.

In such a way as described above, the noise suppression device 1000 according to this exemplary embodiment has an advantageous effect in that the background sound can be estimated efficiently and accurately, in addition to the advantageous effects of the second exemplary embodiment.

### Fourth Exemplary Embodiment

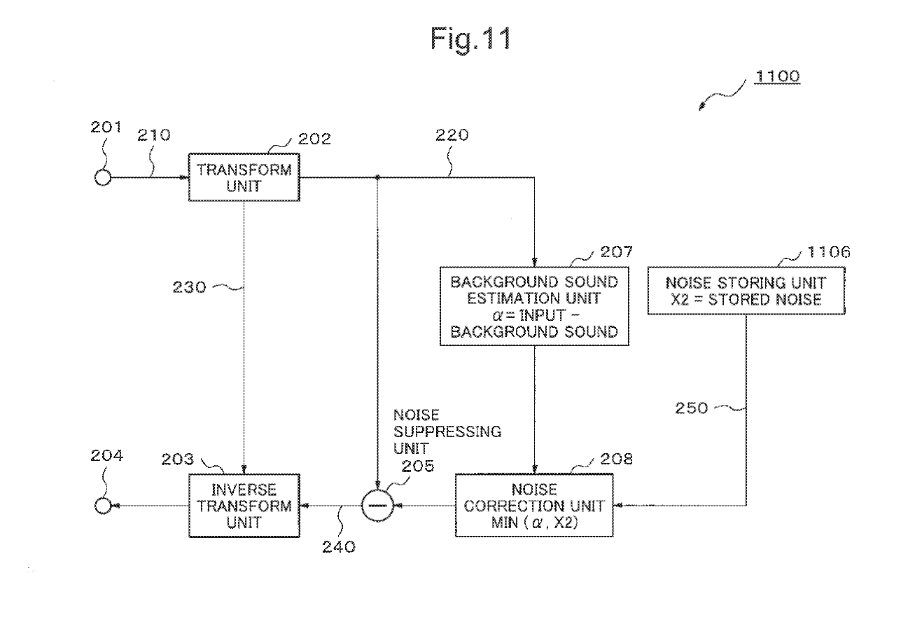

FIG. 11 is a block diagram illustrating a schematic configuration of a noise suppression device 1100 as a fourth exemplary embodiment of the present invention. In the noise suppression device 1100 according to this exemplary embodiment is configured such that, unlike in the case of the second exemplary embodiment, the noise correction unit 208 performs correction using noise information which is read out from a noise storing unit 1106. Since other components and operations thereof are the same as those of the second exemplary embodiment, the same components as those of the second exemplary embodiment are denoted by the same corresponding reference signs as those thereof, and detailed description thereof is omitted here.

The noise storing unit 1106 includes a memory element, such as a semiconductor memory, and stores therein noise information (information related to the characteristics of noise). The noise storing unit 1106 stores therein the shape of a noise spectrum as noise information. The noise storing unit 1106 may store therein feature amounts, such as frequency characteristics of phase, strengths in specific frequencies and a temporal variation, in addition to the spectrum. Besides, the noise information may be any one or more of statistics (a maximum, a minimum, a variance and a median) or the like. In the case where a spectrum is represented by 1024 frequency components, 1024 pieces of data related to amplitude (or power) are stored in the noise storing unit 1106. The noise information 250 recorded in the noise storing unit 1106 is supplied to the noise correction unit 208.

For each frequency component, the noise correction unit 208 selects a smaller one of α (here, α=input−background sound) and X2 (here, X2=stored noise), and outputs the selected α or X2 to the noise suppression unit 205.

The noise suppression device 1100 according to this exemplary embodiment can realize signal processing with high quality, which does not make its output signal smaller than the background sound, and does not cause the discontinuity of its output signal to be perceived, just like in the case of the second exemplary embodiment.

### Fifth Exemplary Embodiment

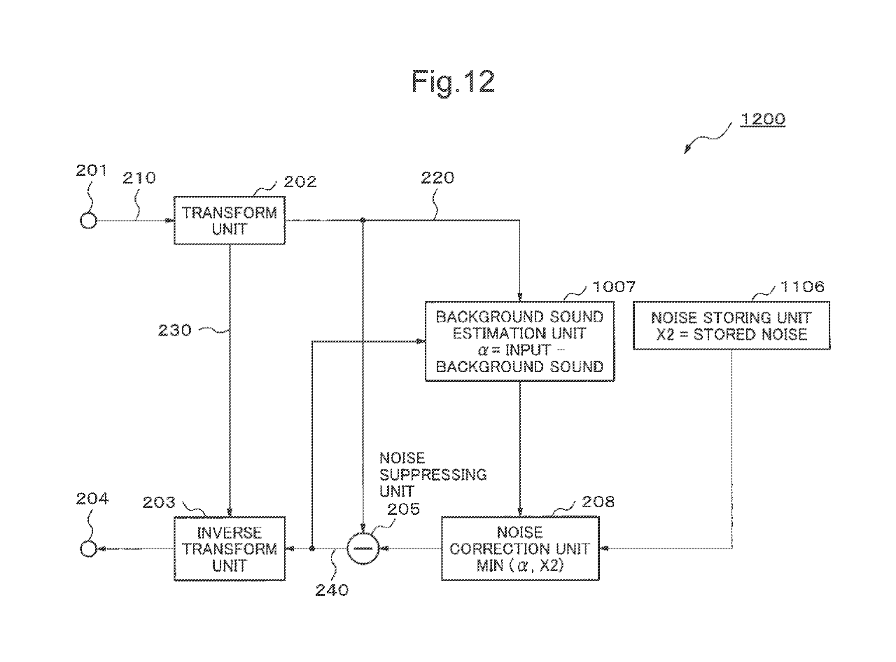

FIG. 12 is a block diagram illustrating a schematic configuration of the noise suppression device 1200 as a fifth exemplary embodiment of the present invention. The noise suppression device 1200 according to this exemplary embodiment is configured such that, unlike in the case of the fourth exemplary embodiment, the output of the noise suppression unit 205 is fed back to the background sound estimation unit 1007. Since other components and operations thereof are the same as those of the fourth exemplary embodiment, the same components as those of the fourth exemplary embodiment are denoted by the same corresponding reference signs as those thereof, and detailed description thereof is omitted here.

The background sound estimation unit 1007 updates background sound information only when no desired signal exists. Operation of the background sound estimation unit 1007 except for this operation is the same as that having been described in the background sound estimation of the second exemplary embodiment, and thus, detailed description thereof is omitted here.

For each frequency component, the noise correction unit 208 selects a smaller one of α and X2, and outputs the selected α or X2 to the noise suppression unit 205.

In this way, the noise suppression device 1200 according to this exemplary embodiment has an advantageous effect in that a background sound can be estimated efficiently and accurately, in addition to the advantageous effect of the fourth exemplary embodiment.

### Sixth Exemplary Embodiment

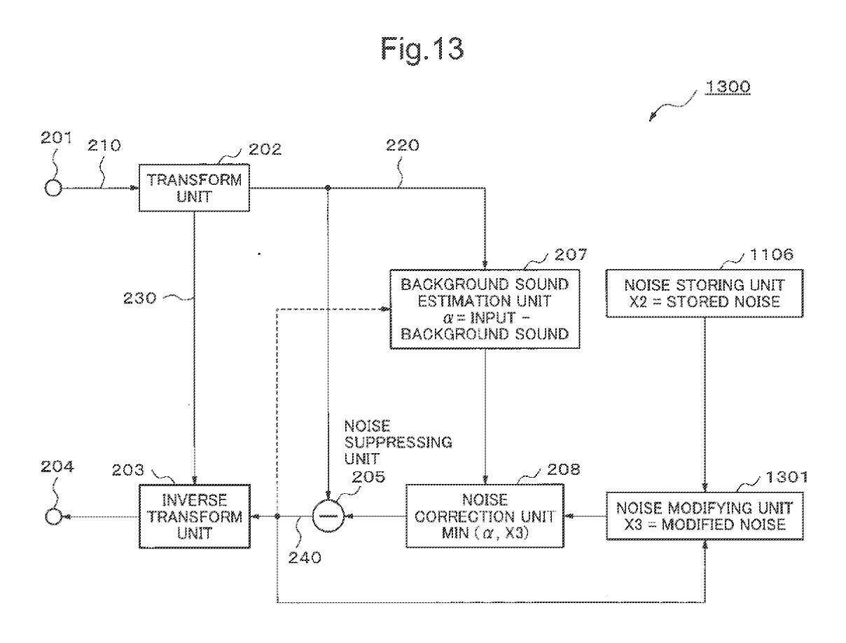

FIG. 13 is a block diagram illustrating a schematic configuration of a noise suppression device 1300 as a sixth exemplary embodiment of the present invention. The noise suppression device 1300 according to this exemplary embodiment is configured such that, unlike in the case of the fourth exemplary embodiment, the output of the noise storing unit 1106 is modified in a noise modifying unit 1301, and then, is supplied to the noise correction unit 208. Since other components and operations thereof are the same as those of the fourth exemplary embodiment, the same components as those of the fourth exemplary embodiment are denoted by the same corresponding reference signs as those thereof, and detailed description thereof is omitted here.

The noise modifying unit 1301 receives the emphasized signal amplitude spectrum 240 supplied from the noise suppression unit 205, and modifies a noise in accordance with the feedback of a noise suppression result. Specifically, the noise modifying unit 1301 updates noise modification information so as to make a noise suppression result zero. For each frequency component, the noise correction unit 208 selects a smaller one of α and X3 (here, X3=modified noise), and outputs the selected a or X3 to the noise suppression unit 205.

According to this exemplary embodiment, just like in the case of the fourth exemplary embodiment, the noise suppression device 1300 can realize signal processing with high quality, which does not make its output signal smaller than a background sound, and does not cause the discontinuity of its output signal to be perceived, and further, can realize a more accurate noise suppression by modifying a noise in accordance with a suppression result.

Further, in this exemplary embodiment, as indicated by a dotted line with an arrow, the output of the noise suppression unit 205 may be fed back to the background sound estimation unit 207. In that case, the background sound estimation unit 207 updates background sound information only when no desired signal exists. The background sound estimation unit 207 is configured such that, for each frequency component, when a desired signal is large, it does not update the background sound. Moreover, the background sound estimation unit 207 does not estimate the background sound when surroundings are noisy. Once the background sound estimation unit 207 estimates a background sound, afterwards, it performs a new estimation operation of the background sound when the amplitude of the noisy speech signal is close to the estimated background sound (when a ratio of or a difference between the both falls within a range between predetermined values). A new estimation operation is performed only when the amplitude of the noisy speech signal is close to the estimated background sound. As the result of this operation, in addition to the aforementioned advantageous effects, the noise suppression device 1300 has an advantageous effect in that a background sound can be estimated efficiently and accurately.

### Seventh Exemplary Embodiment

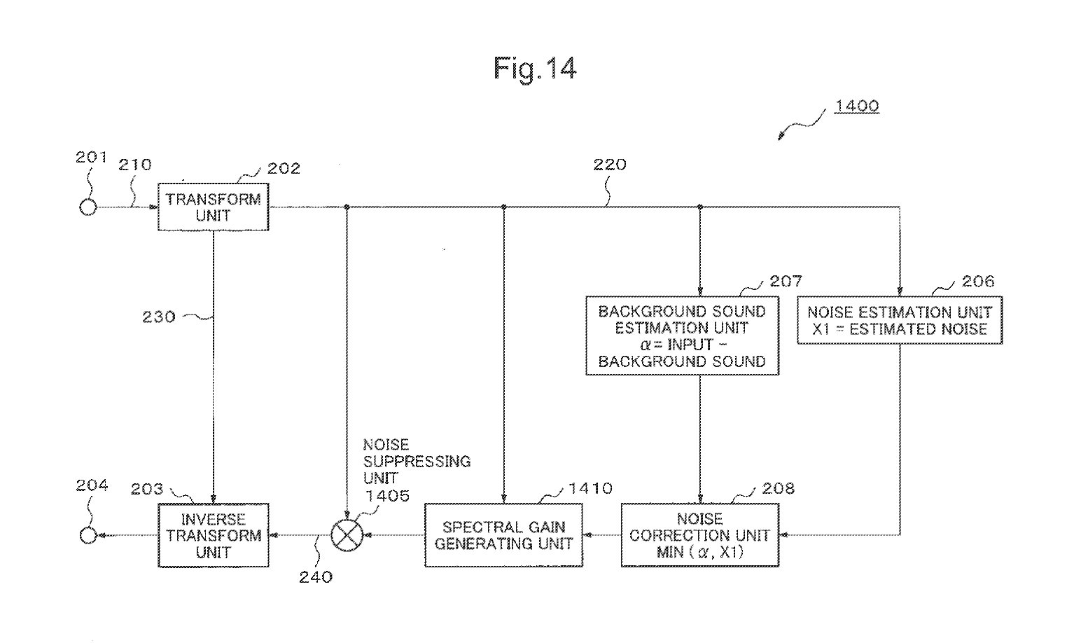

FIG. 14 is a block diagram illustrating a schematic configuration of a noise suppression device 1400 as a seventh exemplary embodiment of the present invention. When comparing FIG. 2 and FIG. 14, the noise suppression device 1400 according to this exemplary embodiment is configured to, unlike in the case of the second exemplary embodiment, include a spectral gain generating unit 1410 which generates spectral gains by using the noise information and the noisy speech signal. Moreover, the noise suppression device 1400 according to this exemplary embodiment includes a noise suppression unit 1405 which performs multiplication. Since other components and operations thereof are the same as those of the second exemplary embodiment, the same components as those of the second exemplary embodiment are denoted by the same corresponding reference signs as those thereof, and detailed description thereof is omitted here.

Configuration of Spectral Gain Generating Unit

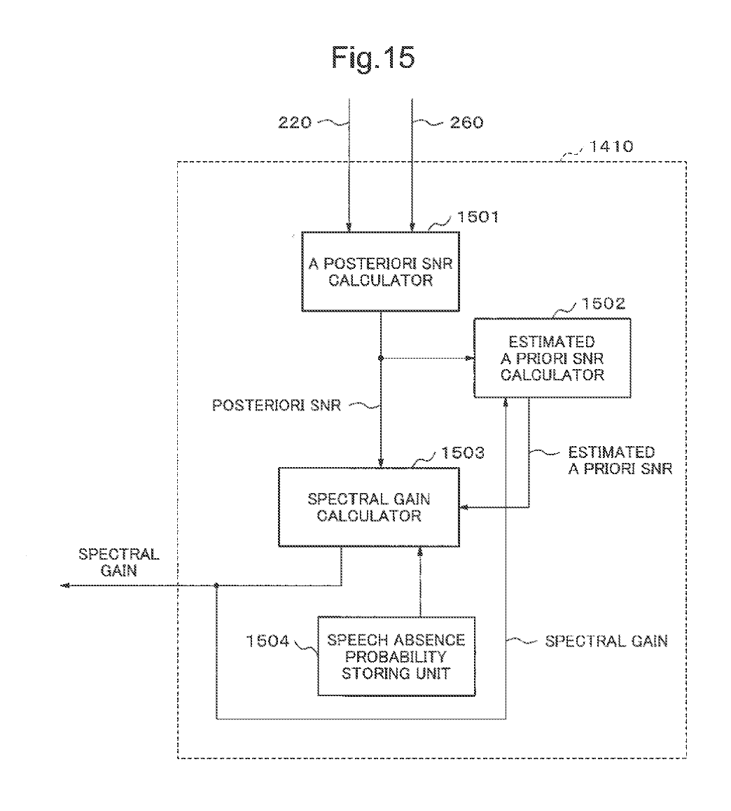

FIG. 15 is a block diagram illustrating a configuration of the spectral gain generating unit 1410 included in FIG. 14. As shown in FIG. 15, the spectral gain generating unit 1410 includes an a-posteriori SNR calculator 1501, an estimated a-priori SNR calculator 1502, a spectral gain calculator 1503 and a speech absence probability storing unit 1504.

The a-posteriori SNR calculator 1501 calculates, for each frequency, an a-posteriori SNR by using an inputted noisy speech power spectrum and an inputted estimated noise power spectrum, and supplies the calculated a-posteriori SNR to the estimated a-priori SNR calculator 1502 and the spectral gain calculator 1503. The estimated a-priori SNR calculator 1502 estimates an a-priori SNR by using an inputted a-posteriori SNR and a spectral gain fed back from the spectral gain calculator 1503, and transmits the a-priori SNR to the spectral gain calculator 1503 as an estimated a-priori SNR. The spectral gain calculator 1503 generates a spectral gain by using the a-posteriori SNR and the estimated a-priori SNR, which are supplied as inputs, as well as a speech absence probability supplied from the speech absence probability storing unit 1504, and outputs the generated spectral gain as a spectral gain Gn(k) bar.

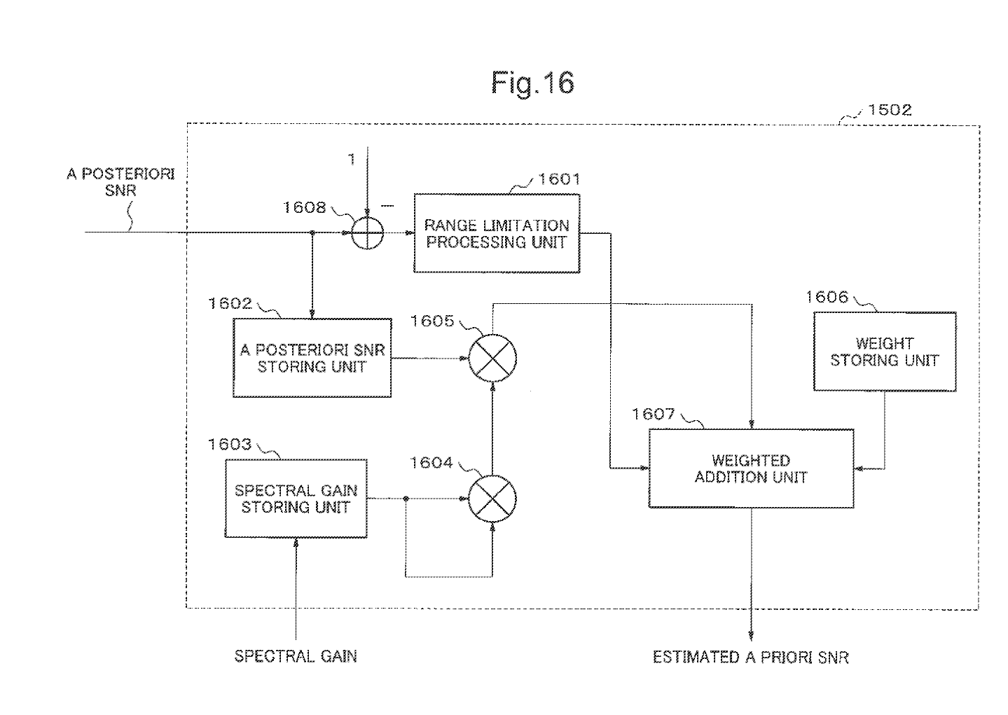

FIG. 16 is block diagram illustrating a configuration of the estimated a-priori SNR calculator 1502 included in FIG. 15. The estimated a-priori SNR calculator 1502 includes a range limitation processing unit 1601, an a-posteriori SNR storing unit 1602, a spectral gain storing unit 1603, multipliers 1604 and 1605, a weight storing unit 1606, a weighted addition unit 1607 and an adder 1608. An a-posteriori SNR γn(k) (k=0, 1, . . . , M−1) supplied from the a-posteriori SNR calculator 1501 is transmitted to the a-posteriori SNR storing unit 1602 and the adder 1608. The a-posteriori SNR storing unit 1602 stores therein an a-posteriori SNR γn(k) at the n-th frame, and at the same time, transmits an a-posteriori SNR γn−1(k) at the (n−1)th frame to the multiplier 1605.

The spectral gain storing unit 1603 stores therein a spectral gain Gn(k) bar at the n-th frame, and at the same time, transmits a spectral gain Gn−1(k) bar at the (n−1)th frame to the multiplier 1604. The multiplier 1604 calculates a Gn−12(k) bar by squaring a supplied Gn(k) bar, and transmits the Gn−12(k) to the multiplier 1605. The multiplier 1605 calculates a Gn−12(k) bar γn−1(k) by multiplying the Gn−12(k) bar by the γn−1(k) at k=0, 1, . . . , M−1, and transmits the calculation result to the weighted addition unit 1607 as an estimated SNR in the past frame.

Another terminal of the adder 1608 is supplied with “−1”, and an addition result γn(k)−1 is transmitted to the range limitation processing unit 1601. The range limitation processing unit 1601 performs an arithmetic operation using a range limitation operator P[*] on the addition result γn(k)−1 supplied from the adder 1608, and transmits the resultant P[γn(k)−1] to the weighted addition unit 1607 as an instantaneous estimated SNR. P[x] is determined by the following equation (13).

$$P [ x ] = \{ \begin{matrix}x , & x > 0 \\ 0 , & x \leq 0\end{matrix} \qquad ( 13 )$$

The weighted addition unit 1607 is further supplied with a weight from the weight storing unit 1606. The weighted addition unit 1607 calculates an estimated a-priori SNR by using these inputs which are the instantaneous estimated SNR, estimated SNR in the past frame and weight. When the weight and the ξn(k) hat to correspond to α and the estimated a-priori SNR, respectively, the ξn(k) hat can be calculated by using the following equation (14). Herein, an equation: Gn−12(k)γ−1(k) bar=1 is satisfied.

\hat{ξ}ₙ(k)=αγₙ₋₁(k) G̅ₙ₋₁²(k)+(1−α)P[γₙ(k)−1] (14)

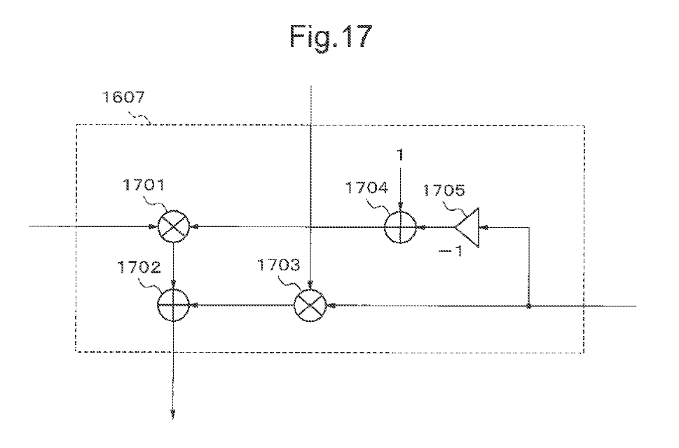

FIG. 17 is a block diagram illustrating a configuration of the weighted addition unit 1607 included in FIG. 16. The weighted addition unit 1607 includes multipliers 1701 and 1703, a fixed number multiplier 1705 and adders 1702 and 1704. The weighted addition unit 1607 is supplied, as inputs, with a frequency-band-dependent instantaneous estimated SNR from the range limitation processing unit 1601 shown in FIG. 16, the frequency-band-dependent SNR from the multiplier 1605 shown in FIG. 16 and the weight from the weight storing unit 1606 shown in FIG. 16. The weight having the value α is transmitted to the fixed number multiplier 1705 and the multiplier 1703. The fixed number multiplier 1705 transmits “−α” resulting from multiplying the input signal by “−1” to the adder 1704. Further, another input of the adder 1704 is “1”, so that the output of the adder 1704 becomes “1−α” which is the sum of the both. Further, “1−α” is supplied to the multiplier 1701, and there, is multiplied by another input, that is, a frequency-band-dependent instantaneous estimated SNR P[γn(k)−1], so that its product, that is, (1−α)P[γn(k)−1], is transmitted to the adder 1702. Meanwhile, in the multiplier 1703, α having been supplied as a weight is multiplied by the estimated SNR in the past frame, and its product, that is, αGn−12(k) bar γn−1(k), is transmitted to adder 1702. The adder 1702 outputs the sum of (1−α)P[γn(k)−1] and αGn−12(k) bar γn−1(k) as a frequency-band-dependent estimated a-priori SNR,

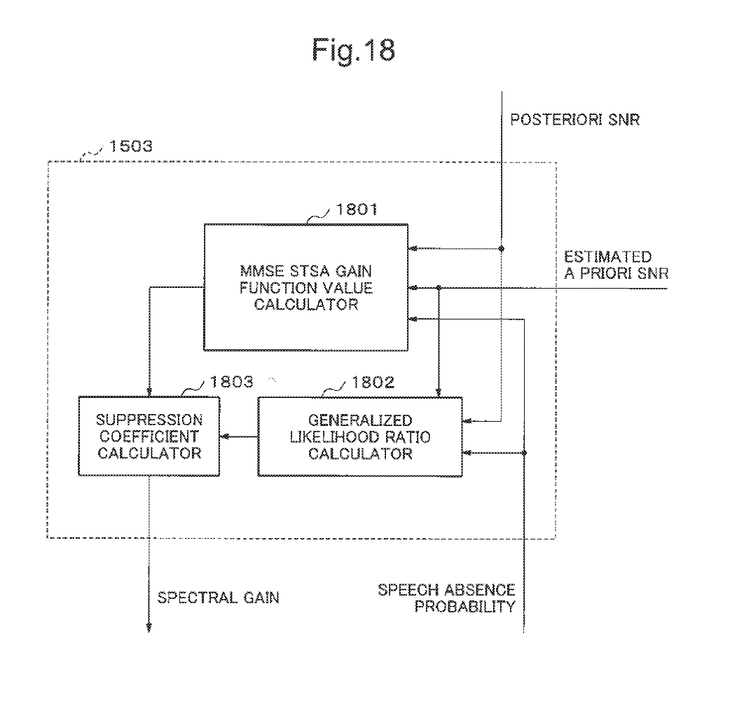

FIG. 18 is a block diagram illustrating the spectral gain calculator 1503 included in FIG. 15. The spectral gain calculator 1503 includes an MMSE STSA gain function value calculator 1801, a generalized likelihood ratio calculator 1802 and a spectral gain calculator 1803. Hereinafter, a method for calculating a spectral gain will be described on the basis of calculation equations which are described in IEEE TRANSACTIONS ON ACOUSTICS, SPEECH, AND SIGNAL PROCESSING, Vol. 32, No. 6, pp. 1109-1121, December 1984.

N represents a frame number, and k represents a frequency number. γn(k) represents a frequency-dependent a-posteriori SNR supplied from the a-posteriori SNR calculator 1501; ξn(k) hat represents a frequency-dependent estimated a-priori SNR supplied from the estimated a-priori SNR calculator 1502; and q represents a speech absence probability supplied from the speech absence probability storing unit 1504.

Here, the following equations are satisfied: ηn(k)=ξn(k) hat/(1−q), and vn(k)=(ηn(k)γn(k))/(1+ηn(k)).

The MMSE STSA gain function value calculator 1801 calculates an MMSE STSA gain function value for each frequency band on the basis of the a-posteriori SNR γn(k) supplied from the a-posteriori SNR calculator 1501, the estimated a-priori SNR ξn(k) hat supplied from the estimated a-priori SNR calculator 1502, and the speech absence probability q supplied from the speech absence probability storing unit 1504, and the MMSE STSA gain function value calculator 1801 outputs the calculated MMSE STSA gain function value to the spectral gain calculator 1803. The MMSE STSA gain function value Gn(k) for each frequency band is given by the following equation (15).

$${G}_{n} ( k ) = \frac{\sqrt{π}}{2} \frac{\sqrt{{v}_{n} ( k )}}{{γ}_{n} ( k ) + 1} exp ( - \frac{{v}_{n} ( k )}{2} ) [ ( 1 + {v}_{n} ( k ) ) {I}_{0} ( \frac{{v}_{n} ( k )}{2} ) + {v}_{n} ( k ) {I}_{1} ( \frac{{v}_{n} ( k )}{2} ) ] \qquad ( 15 )$$

Here, I0 (z) is a zero-order modified Bessel function, and I1 (z) is a first-order modified Bessel function. The modified Bessel function is described in “Iwanami Sugaku Jiten” (written in Japanese), Iwanami Shoten, Publishers, 374, G page (its English version is Encyclopedic Dictionary of Mathematics).

The generalized likelihood ratio calculator 1802 calculates a generalized likelihood ratio for each frequency band on the basis of the a-posteriori SNR γn(k) supplied from the a-posteriori SNR calculator 1501, the estimated a-priori SNR ξn(k) hat supplied from the estimated a-priori SNR calculator 1502, and the speech absence probability q supplied from the speech absence probability storing unit 1504, and transmits the generalized likelihood ratio to the spectral gain calculator 1803. The generalized likelihood ratio Λn(k) for each frequency band is given by the following equation (16).

$${Λ}_{n} ( k ) = \frac{1 - q}{q} \frac{exp ( {v}_{n} ( k ) )}{1 + {η}_{n} ( k )} \qquad ( 16 )$$

The spectral gain calculator 1803 calculates a spectral gain for each frequency band from the MMSE STSA gain function value Gn(k) supplied from the MMSE STSA gain function value calculator 1801, and the generalized likelihood ratio Λn(k) supplied from the generalized likelihood ratio calculator 1802. A spectral gain Gn(k) bar for each frequency band is given by the following equation (17).

$${\overline{G}}_{n} ( k ) = \frac{{Λ}_{n} ( k )}{q {Λ}_{n} ( k ) + 1} {G}_{n} ( k ) \qquad ( 17 )$$

The spectral gain calculator 1803 may calculate an SNR common to a wide frequency band including a plurality of frequency bands, and may use this SNR instead of calculating SNRs for the respective frequency bands.

In such a configuration as described above, the noise suppression device 1400 also controls, in the noise suppression using the spectral gain, such that a noise becomes small in accordance with a ratio of a desired signal and the noise, thereby can realize signal processing with high quality. That is, the noise suppression device 1400 according to this exemplary embodiment can realize signal processing with high quality, which does not make its output signal smaller than a background sound, and does not cause the discontinuity of its output signal to be perceived, just like in the case of the second exemplary embodiment, and further, can realize a more accurate noise suppression.

### Eighth Exemplary Embodiment

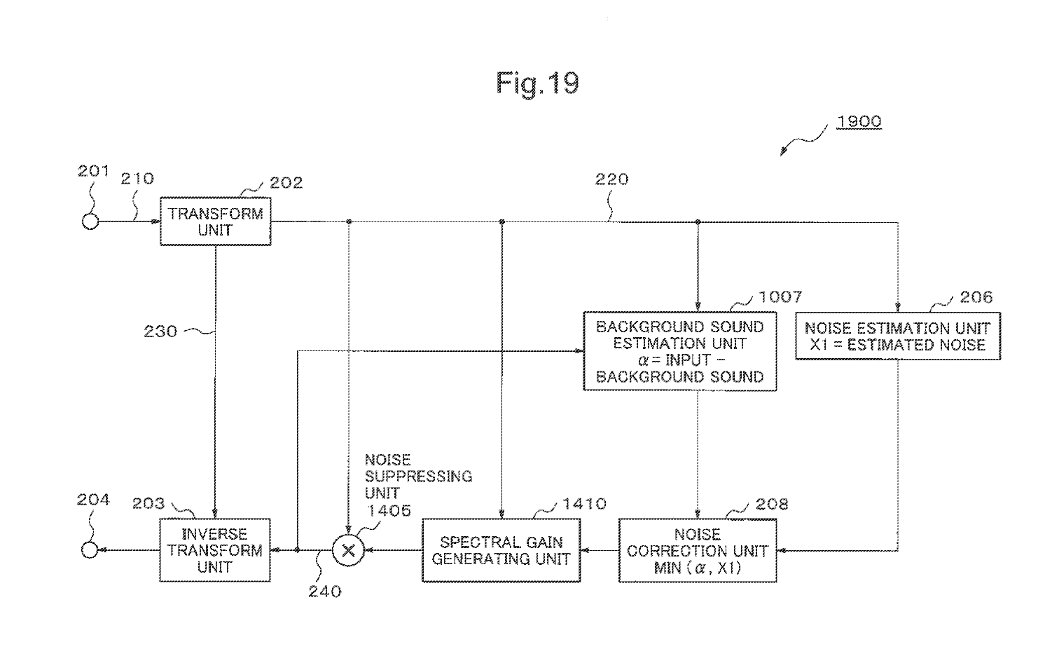

FIG. 19 is a block diagram illustrating a schematic configuration of a noise suppression device 1900 as an eighth exemplary embodiment of the present invention. The noise suppression device 1900 according to this exemplary embodiment is configured such that, unlike in the case of the seventh exemplary embodiment (FIG. 14), the output of the noise suppression unit 1405 is fed back to the background sound estimation unit 1007.

The background sound estimation unit 1007 updates background sound information only when no desired signal exists. The background sound estimation unit 1007 is configured such that, for each frequency component, when a desired signal is large, it does not update the background sound. Moreover, the background sound estimation unit 1007 does not estimate the background sound when surroundings are noisy. Once the background sound estimation unit 1007 estimates a background sound, afterwards, it performs a new estimation operation of the background sound when the amplitude of the noisy speech signal is close to the estimated background sound (when a ratio of or a difference between the both falls within a range between predetermined values). The background sound estimation unit 1007 performs a new estimation operation only when the amplitude of the noisy speech signal is close to the estimated background sound.

As the result of this operation, in addition to the aforementioned advantageous effects, the noise suppression device 1900 has an advantageous effect in that a background sound can be estimated efficiently and accurately.

### Ninth Exemplary Embodiment

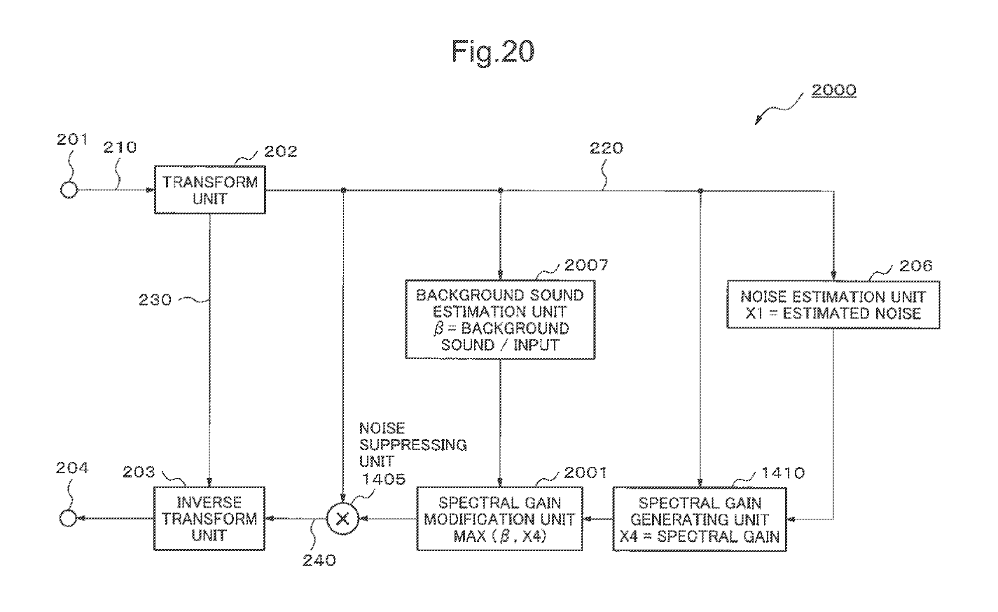

FIG. 20 is a block diagram illustrating a schematic configuration of a noise suppression device 2000 as a ninth exemplary embodiment of the present invention. The noise suppression device 2000 according to this exemplary embodiment is configured such that, unlike in the case of the seventh exemplary embodiment (FIG. 14), it does not include the noise correction unit 208, and as a substitution therefore, it includes a spectral gain modification unit 2001 which modifies the spectral gain supplied from the spectral gain generating unit 1410 in accordance with a background sound. Further, the background sound estimation unit 2007 receives the amplitude of a noisy speech signal from the transform unit 202, and estimates a background sound. The background sound estimation unit 2007 further calculates a ratio β of the background sound estimated value and an input, and supplies the ratio β to the spectral gain modification unit 2001. Since other components and operations thereof are the same as those of the fifth exemplary embodiment, the same components as those of the fifth exemplary embodiment are denoted by the same corresponding reference signs as those thereof, and detailed description thereof is omitted here.

The spectral gain modification unit 2001 modifies the spectral gain generated by the spectral gain generating unit 1410 in accordance with an important degree of an input signal (frequency).

In this way, the spectral gain modification unit 2001 makes a spectral gain small for a frequency component signal, in which a background sound signal is estimated to be present, and thereby restricts the suppression of the signal performed by the noise suppression unit 1405.

In this way, since, similarly, in the noise suppression using the spectral gain, the spectral gain is controlled so as to be made small in accordance with a ratio of a desired signal and a noise, thereby can realize signal processing with high quality. That is, according to this exemplary embodiment, the noise suppression device 2000 also can realize signal processing with high quality, which does not make its output signal smaller than a background sound, and does not cause the discontinuity of its output signal to be perceived, just like in the case of the second exemplary embodiment, and further, can realize a more accurate noise suppression.

### Tenth Exemplary Embodiment

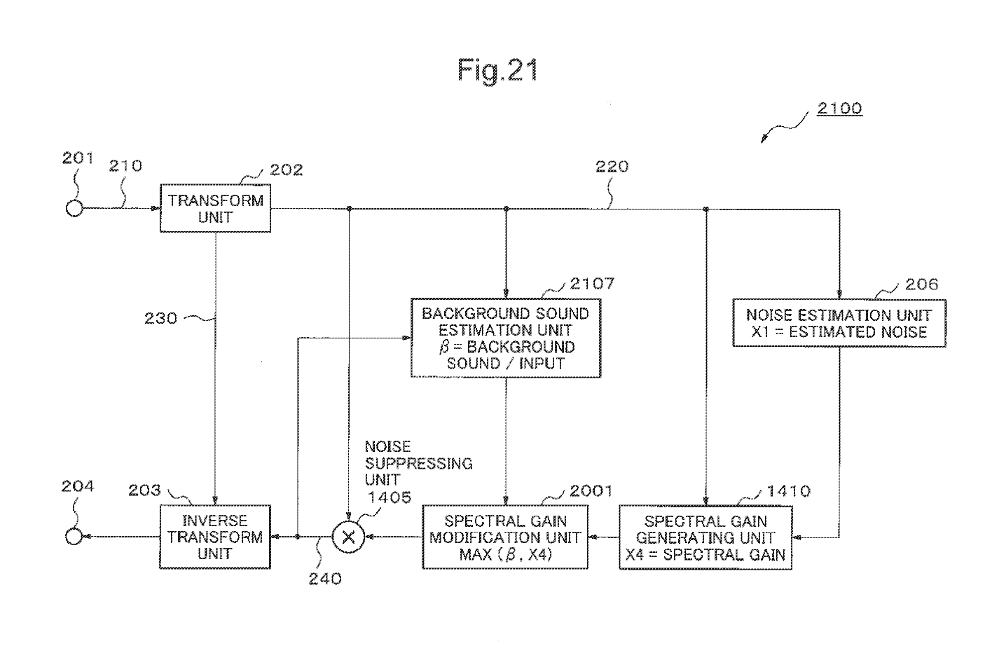

FIG. 21 is a block diagram illustrating a schematic configuration of a noise suppression device 2100 as a tenth exemplary embodiment of the present invention. The noise suppression device 2100 according to this exemplary embodiment is configured such that, in addition to the configuration of the ninth exemplary embodiment (FIG. 20), the output of the noise suppression unit 1405 is fed back to a background sound estimation unit 2107.

The background sound estimation unit 2107 updates background sound information only when no desired signal exists. The background sound estimation unit 2107 is configured such that, for each frequency component, when a desired signal is large, it does not update the background sound. Moreover, the background sound estimation unit 2107 does not estimate the background sound when surroundings are noisy. Once the background sound estimation unit 2107 estimates a background sound, afterwards, it performs a new estimation operation of the background sound when the amplitude of the noisy speech signal is close to the estimated background sound (when a ratio of or a difference between the both falls within a range between predetermined values). The background sound estimation unit 2107 performs a new estimation operation only when the amplitude of the noisy speech signal is close to the estimated background sound.

As the result of this operation, in addition to the aforementioned advantageous effects of the ninth exemplary embodiment, the noise suppression device 2100 has an advantageous effect in that a background sound can be estimated efficiently and accurately.

### Eleventh Exemplary Embodiment

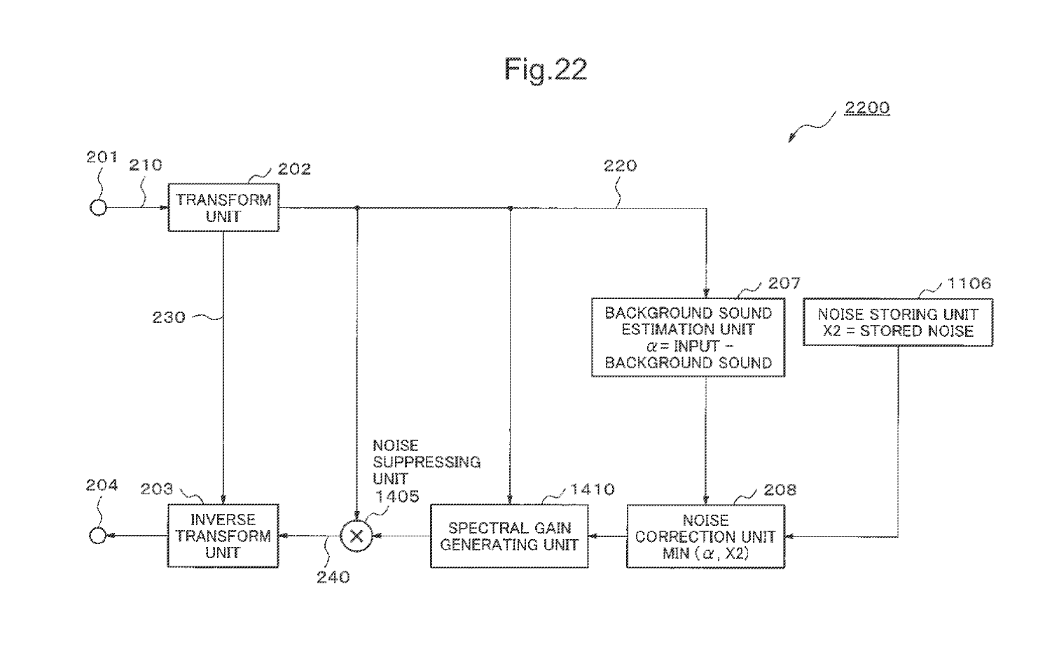

FIG. 22 is a block diagram illustrating a schematic configuration of a noise suppression device 2200 as a eleventh exemplary embodiment of the present invention. As compared with the configuration of the seventh exemplary embodiment (FIG. 14), the noise suppression device 2200 according to this exemplary embodiment does not include the noise estimation unit 206. The noise correction unit 208 performs correction by using noise information read out from the noise storing unit 1106. Since other components and operations thereof are the same as those of the second exemplary embodiment, the same components as those of the second exemplary embodiment are denoted by the same corresponding reference signs as those thereof, and detailed description thereof is omitted here. The noise correction unit 208 selects, for each frequency component, a smaller one of α(=input−background sound) and X2 (=stored noise), and outputs the selected α or X2 to the spectral gain generating unit 1410.

According to this exemplary embodiment, similarly, the noise suppression device 2200 controls so as to make a noise small in accordance with a ratio of a desired signal and the noise, just like in the case of the seventh exemplary embodiment, and thus, can realize signal processing with high quality.

### Twelfth Exemplary Embodiment

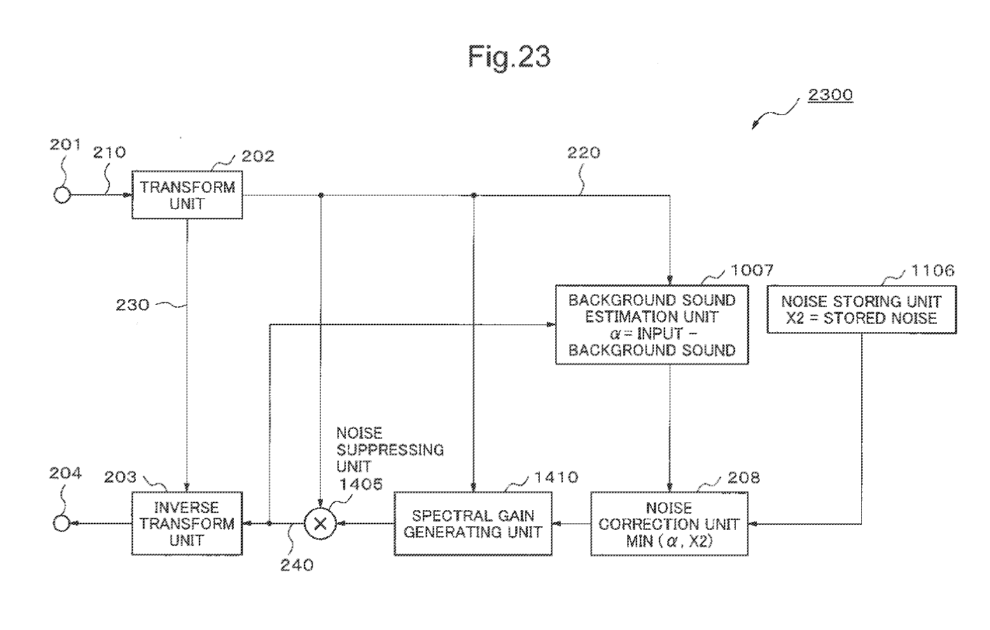

FIG. 23 is a block diagram illustrating a schematic configuration of a noise suppression device 2300 as a twelfth exemplary embodiment of the present invention. The noise suppression device 2300 according to this exemplary embodiment is configured such that, in addition to the configuration of the eleventh exemplary embodiment (FIG. 22), the output of the noise suppression unit 1405 is fed back to the background sound estimation unit 1007.

The background sound estimation unit 1007 updates background sound information only when no desired signal exists. The background sound estimation unit 1007 is configured such that, for each frequency component, when a desired signal is large, it does not update the background sound. Moreover, the background sound estimation unit 1007 does not estimate the background sound when surroundings are noisy. Once the background sound estimation unit 1007 estimates a background sound, afterwards, it performs a new estimation operation of the background sound when the amplitude of the noisy speech signal is close to the estimated background sound (when a ratio of or a difference between the both falls within a range between predetermined values). The background sound estimation unit 1007 performs a new estimation operation only when the amplitude of the noisy speech signal is close to the estimated background sound.

As the result of this operation, in addition to the aforementioned advantageous effects of the eleventh exemplary embodiment, the noise suppression device 2300 has an advantageous effect in that a background sound can be estimated efficiently and accurately.

### Thirteenth Exemplary Embodiment

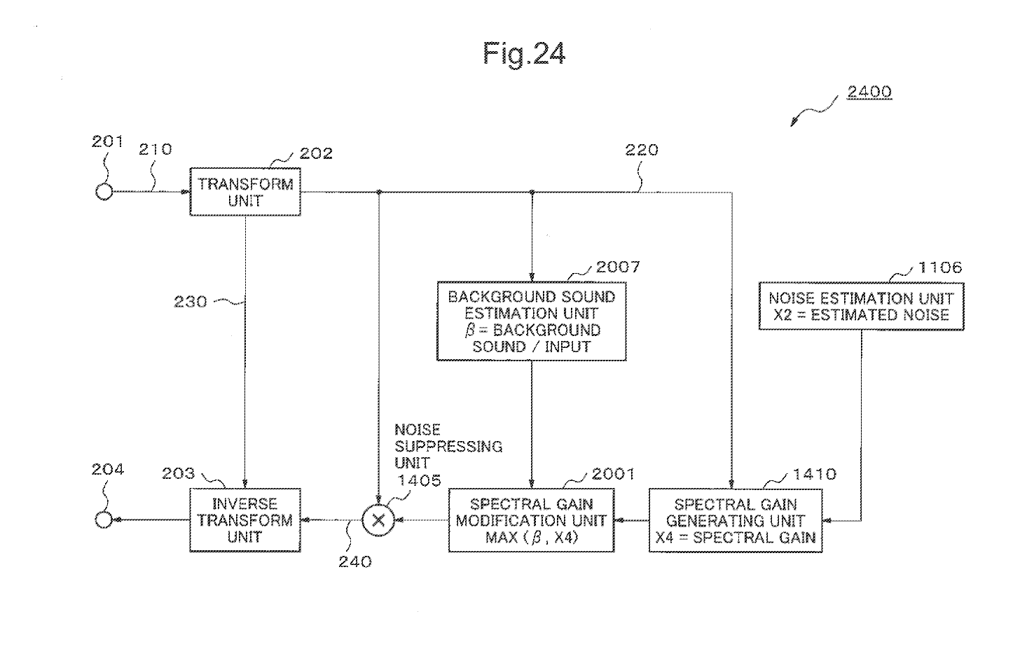

FIG. 24 is a block diagram illustrating a schematic configuration of a noise suppression device 2400 as a thirteenth exemplary embodiment of the present invention. When comparing FIG. 20 and FIG. 24, the noise suppression device 2400 according to this exemplary embodiment does not include the noise estimation unit 206 of the ninth exemplary embodiment (FIG. 20). The spectral gain generating unit 1410 generates a spectral gain by using noise information which is read out from the noise storing unit 1106. Since other components and operations thereof are the same as those of the ninth exemplary embodiment, the same components as those of the ninth exemplary embodiment are denoted by the same corresponding reference signs as those thereof, and detailed description thereof is omitted here.

According to this exemplary embodiment, similarly, the noise suppression device 2400 controls so as to make a noise small in accordance with a ratio of a desired signal and the noise, just like in the case of the ninth exemplary embodiment, and thus, can realize signal processing with high quality.

### Fourteenth Exemplary Embodiment

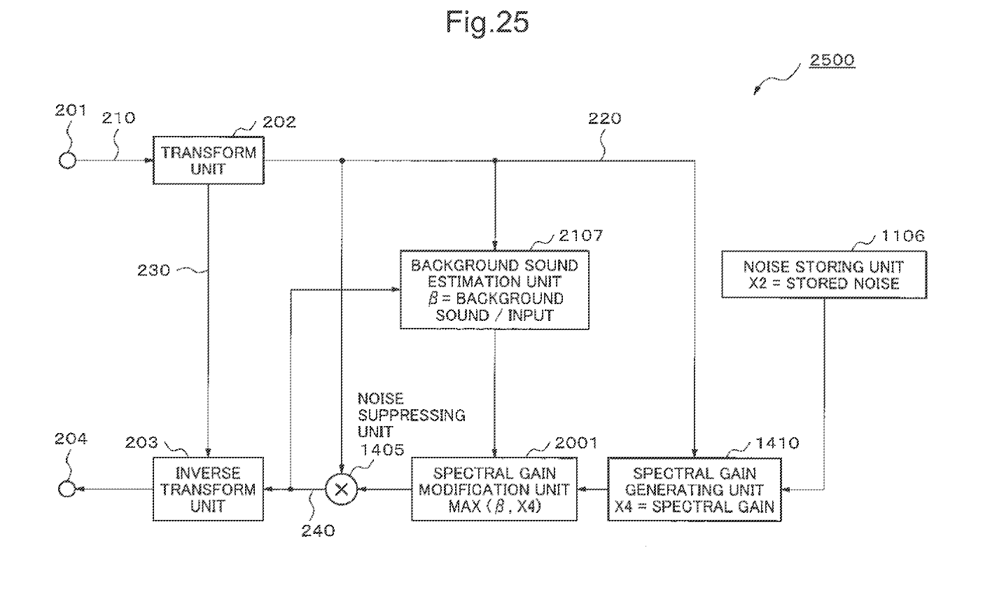

FIG. 25 is a block diagram illustrating a schematic configuration of a noise suppression device 2500 as a fourteenth exemplary embodiment of the present invention. The noise suppression device 2500 according to this exemplary embodiment is configured such that, in addition to the configuration of the thirteenth exemplary embodiment (FIG. 24), the output of the noise suppression unit 1405 is fed back to the background sound estimation unit 2107.

The background sound estimation unit 2107 updates background sound information only when no desired signal exists. The background sound estimation unit 2107 is configured such that, for each frequency component, when a desired signal is large, it does not update the background sound. Moreover, the background sound estimation unit 2107 does not estimate the background sound when surroundings are noisy. Once the background sound estimation unit 2107 estimates a background sound, afterwards, it performs a new estimation operation of the background sound when the amplitude of the noisy speech signal is close to the estimated background sound (when a ratio of or a difference between the both falls within a range between predetermined values). The background sound estimation unit 2107 performs a new estimation operation only when the amplitude of the noisy speech signal is close to the estimated background sound.

As the result of this operation, in addition to the aforementioned advantageous effects of the thirteen exemplary embodiment, the noise suppression device 2500 has an advantageous effect in that a background sound can be estimated efficiently and accurately.

### Fifteenth Exemplary Embodiment

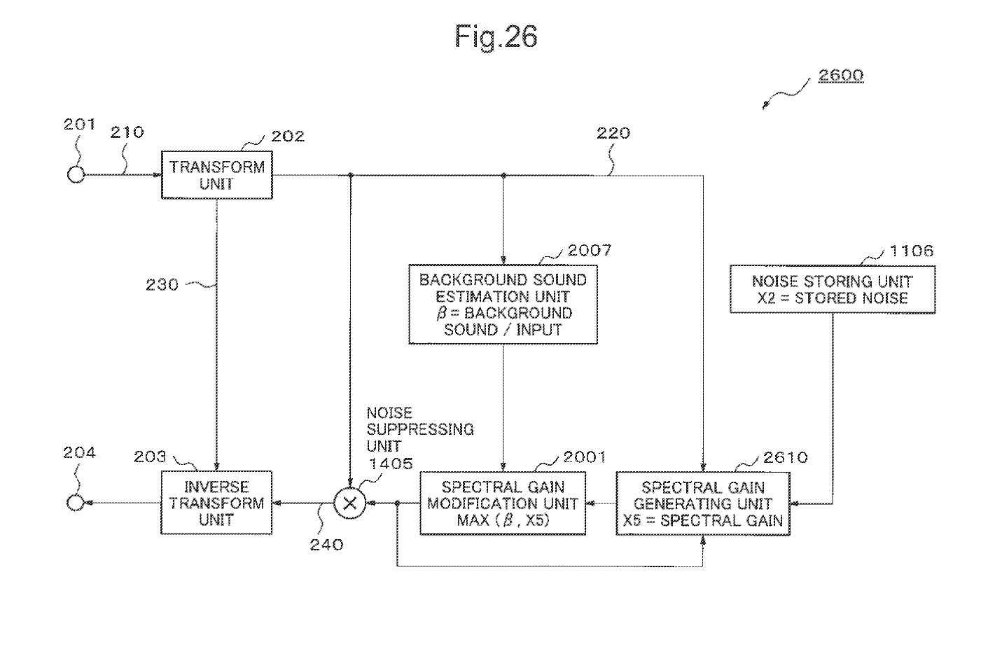

FIG. 26 is a block diagram illustrating a schematic configuration of a noise suppression device 2600 as a fifteenth exemplary embodiment of the present invention. The noise suppression device 2600 according to this exemplary embodiment is configured such that, in addition to the configuration of the fourteenth exemplary embodiment (FIG. 25), the spectral gain resulting from the modification in the spectral gain modification unit 2001 are fed back to a spectral gain generating unit 2610. The spectral gain generating unit 2610 generates a next spectral gain by using the fed-back spectral gain. This operation increases the accuracy of the spectral gain, and thus, leads to the improvement of a sound quality.

Since other components and operations thereof are the same as those of the fourteenth exemplary embodiment, the same components as those of the fourteenth exemplary embodiment are denoted by the same corresponding reference signs as those thereof, and detailed description thereof is omitted here.

According to this exemplary embodiment, similarly, the noise suppression device 2600 controls so as to make a noise small in accordance with a ratio of a desired signal and the noise, just like in the case of the fourteenth exemplary embodiment, and thus, can realize signal processing with high quality, and further, can realize a more accurate noise suppression.

### Sixteenth Exemplary Embodiment

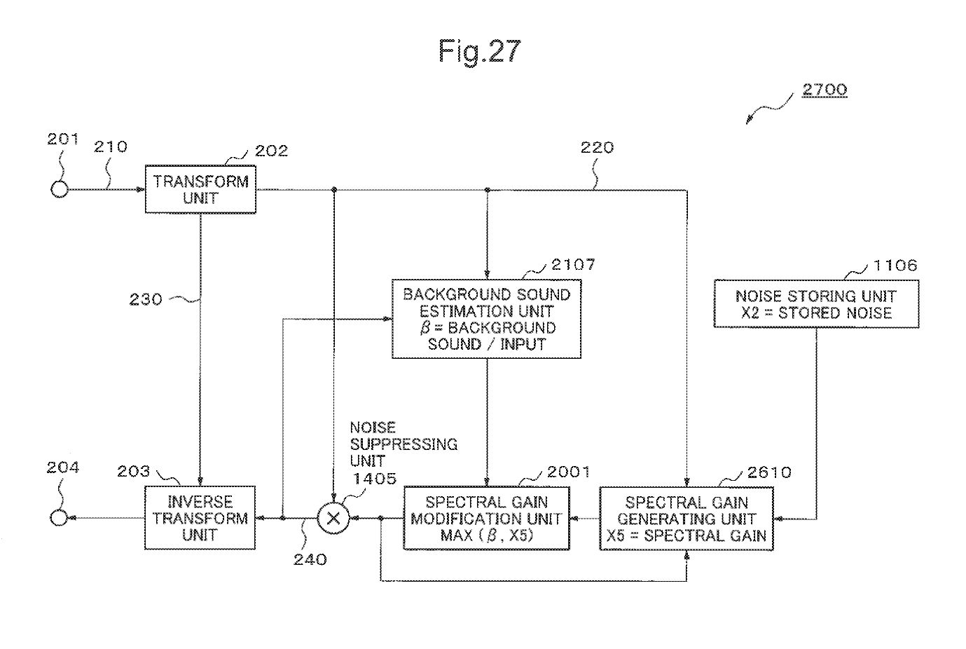

FIG. 27 is a block diagram illustrating a schematic configuration of a noise suppression device 2700 as a sixteenth exemplary embodiment of the present invention. The noise suppression device 2700 according to this exemplary embodiment is configured such that, in addition to the configuration of the fifteenth exemplary embodiment (FIG. 26), the output of the noise suppression unit 1405 is fed back to the background sound estimation unit 2107.

The background sound estimation unit 2107 updates background sound information only when no desired signal exists. The background sound estimation unit 2107 is configured such that, for each frequency component, when a desired signal is large, it does not update the background sound. Moreover, the background sound estimation unit 2107 does not estimate the background sound when surroundings are noisy. Once the background sound estimation unit 2107 estimates a background sound, afterwards, it performs a new estimation operation of the background sound when the amplitude of the noisy speech signal is close to the estimated background sound (when a ratio of or a difference between the both falls within a range between predetermined values). The background sound estimation unit 2107 performs a new estimation operation only when the amplitude of the noisy speech signal is close to the estimated background sound.

As the result of this operation, in addition to the aforementioned advantageous effects of the fifteenth exemplary embodiment, the noise suppression device 2700 has an advantageous effect in that a background sound can be estimated efficiently and accurately.

### Seventeenth Exemplary Embodiment

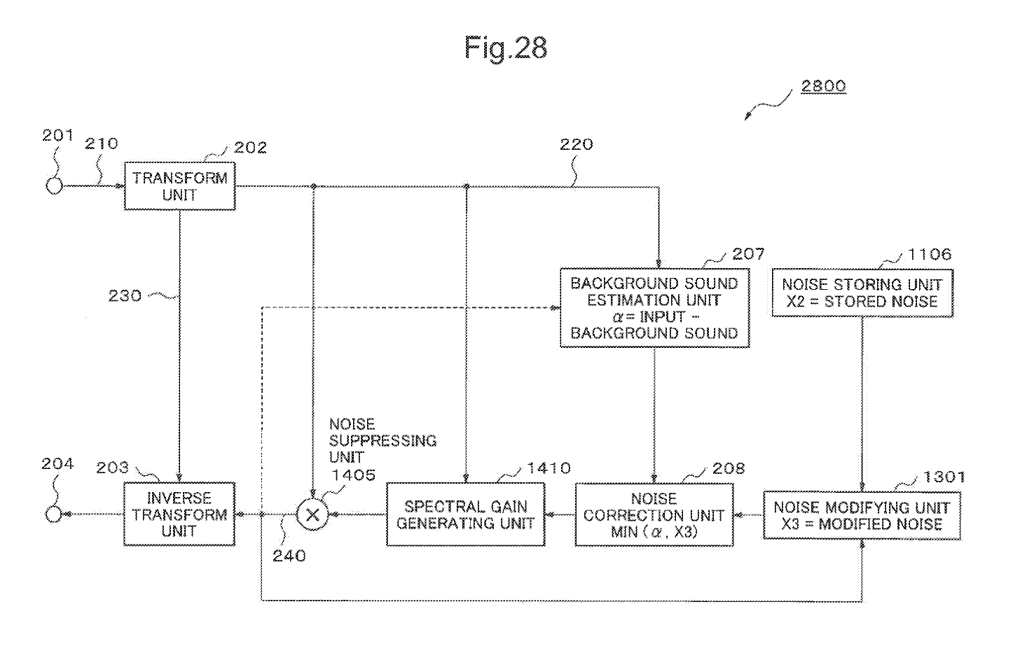

FIG. 28 is a block diagram illustrating a schematic configuration of a noise suppression device 2800 as a seventeenth exemplary embodiment of the present invention. The noise suppression device 2800 according to this exemplary embodiment includes the noise modifying unit 1301 in addition to the configuration of the eleventh exemplary embodiment (FIG. 22). The noise suppression device 2800 causes the noise correction unit 1301 to modify the output from the noise storing unit 1106, and supplies the modified noise information to the noise correction unit 208. The noise correction unit 1301 receives the output 240 from the noise suppression unit 1405, and modifies noise in accordance with the feedback of the noise suppression result.

Since other components and operations thereof are the same as those of the eleventh exemplary embodiment, the same components as those of the eleventh exemplary embodiment are denoted by the same corresponding reference signs as those thereof, and detailed description thereof is omitted here.

According to this exemplary embodiment, similarly, the noise suppression device 2800 controls so as to make a noise small in accordance with a ratio of a desired signal and the noise, just like in the case of the eleventh exemplary embodiment, and thus, can realizes signal processing with high quality, and further, modifies the noise in accordance with the suppression result, thereby can realizes a more accurate noise suppression.

### Eighteenth Exemplary Embodiment

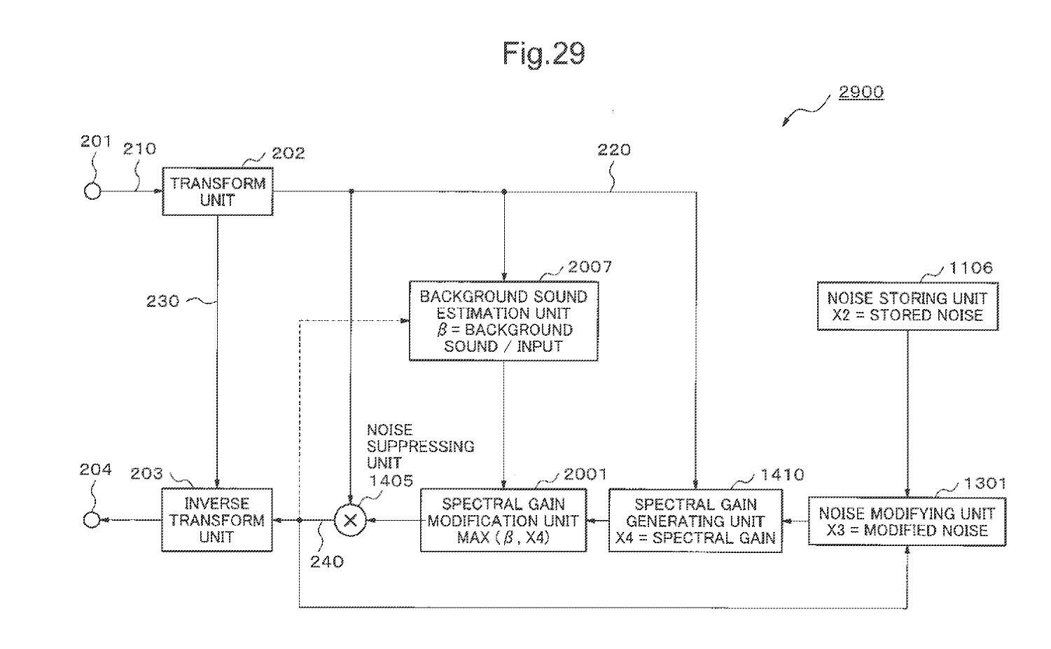

FIG. 29 is a block diagram illustrating a schematic configuration of a noise suppression device 2900 as an eighteenth exemplary embodiment of the present invention. The noise suppression device 2900 according to this exemplary embodiment includes the noise modifying unit 1301 in addition to the configuration of the thirteenth exemplary embodiment (FIG. 24). The noise suppression device 2900 causes the noise modifying unit 1301 to modify the output of the noise storing unit 1106, and supply the modified noise information to the spectral gain generating unit 1410. The noise modifying unit 1301 receives the output 240 from the noise suppression unit 1405, and modifies noise in accordance with the feedback of the noise suppression result.

Since other components and operations thereof are the same as those of the thirteenth exemplary embodiment, the same components as those of the thirteenth exemplary embodiment are denoted by the same corresponding reference signs as those thereof, and detailed description thereof is omitted here.

According to this exemplary embodiment, similarly, the noise suppression device 2900 controls so as to make a noise small in accordance with a ratio of a desired signal and the noise, just like in the case of the eleventh exemplary embodiment, and thus, can realize signal processing with high quality, and further, modifying the noise in accordance with the suppression result, thereby can realize a more accurate noise suppression.

### Nineteenth Exemplary Embodiment

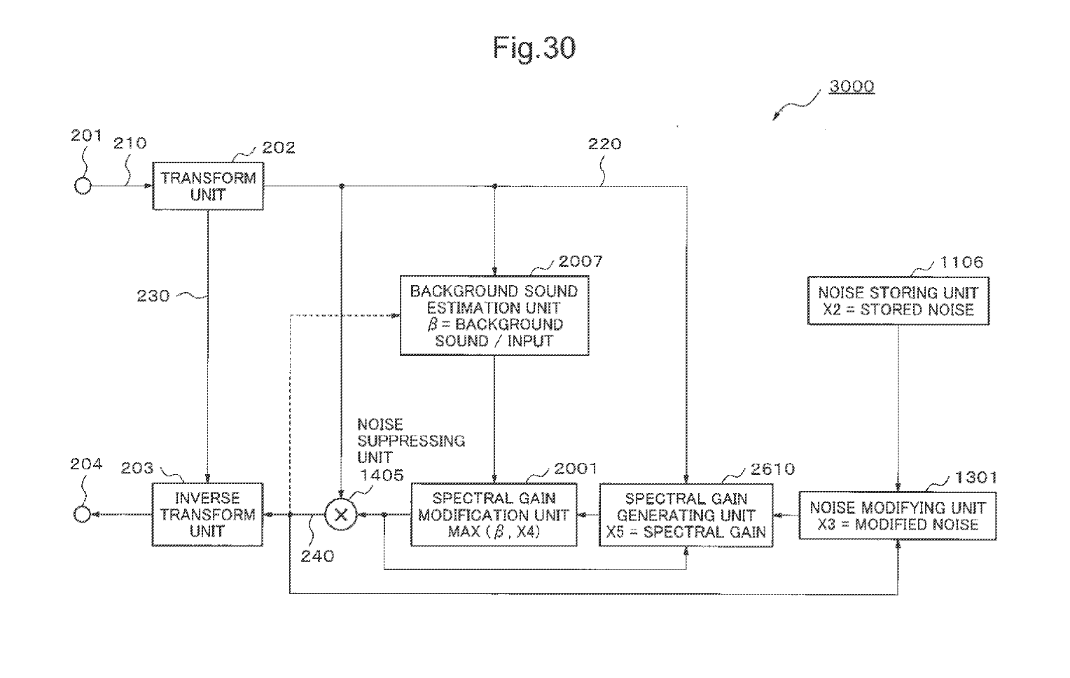

FIG. 30 is a block diagram illustrating a schematic configuration of a noise suppression device 3000 as a nineteenth exemplary embodiment of the present invention. The noise suppression devices 3000 according to this exemplary embodiment includes the configuration of the eighteenth exemplary embodiment (FIG. 29), and further feeds back the spectral gain resulting from the modification in the spectral gain modification unit 2001 to the spectral gain generating unit 2610. The spectral gain generating unit 2610 generates a next spectral gain by using the fed-back spectral gain. This operation increases the accuracy of the spectral gain, and further leads to the improvement of a sound quality.

Since other components and operations thereof are the same as those of the eighteenth exemplary embodiment, the same components as those of the eighteenth exemplary embodiment are denoted by the same corresponding reference signs as those thereof, and detailed description thereof is omitted here.

According to this exemplary embodiment, similarly, the noise suppression device 3000 controls so as to make a noise small in accordance with a ratio of a desired signal and the noise, just like in the case of the eighteenth exemplary embodiment, and thus, can realize signal processing with high quality, and further, can realize a more accurate noise suppression because of the feedback of the spectral gain.

### Other Embodiments

In the first to nineteenth exemplary embodiments above, the noise suppression devices having respective different features have been described, but noise suppression devices each resulting from combining the features arbitrarily are also included in the scope of the present invention.

Further, the present invention may be applied to a system including a plurality of devices, and may be also applied to a single device. Moreover, the present invention can be also applied to a case where a signal processing program, which is software to realize the functions of the aforementioned exemplary embodiments, is supplied to a system or a device directly or from a remote. Accordingly, in order to cause a computer to realize the functions according to aspects of the present invention, a program which is installed in the computer, a medium which stores the program therein, and a WWW server which allows the program to be downloaded to the computer are also included in the scope of the present invention.

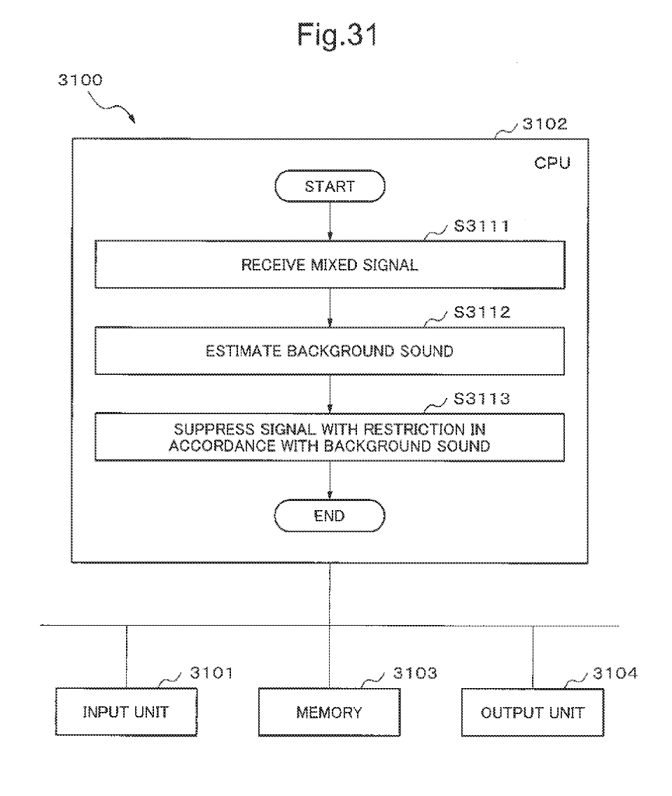

FIG. 31 is a block diagram of a computer 3100 which executes a signal processing program in the case where the first exemplary embodiment is realized by the signal processing program. The computer 3100 includes an input unit 3101, a CPU 3102, a memory 3103 and an output unit 3104.

The CPU 3102 controls the operation of the computer 3100 by reading in the signal processing program.

That is, the CPU 3102 executes the signal processing program stored in the memory 3103, and thereby receives a mixed signal in which a first signal and a second signal are mixed in (S3111). Next, the CPU 3102 estimates the background sound signal contained in the mixed signal (S3112). Subsequently, the CPU 3102 suppresses the second signal along with restriction such that the result of the suppression does not become smaller than the estimated background sound signal (S3113). In this way, it is possible to obtain the same advantageous effects as those of the first exemplary embodiment.

Hereinbefore, the present invention has been described with reference to the exemplary embodiments thereof, but the present invention is not limited to these exemplary embodiments. Various changes understandable by the skilled in the art can be made on the configuration and the details of the present invention within the scope of the present invention.

This application is based upon and claims the benefit of priority from Japanese Patent Application No. 2012-263022, filed on Nov. 25, 2010, the disclosure of which is incorporated herein in its entirety by reference.

1-9. (canceled)

10. A signal processing device comprising:
a suppression unit which performs suppression of a second signal by processing a mixed signal in which a first signal and said second signal are contained;
a background sound estimation unit which estimates a background sound signal in said mixed signal; and
a restriction unit which restricts said suppression of said second signal such that a suppression result outputted by said suppression means does not become smaller than said estimated background sound signal.

11. The signal processing device according to claim 10, further comprising:
an estimation unit which estimates said second signal contained in said mixed signal,
wherein said restriction unit corrects said estimated second signal outputted from said estimation means in accordance with said background sound signal, and
said suppression unit subtracts said corrected estimated second signal from said mixed signal to restrict said suppression.

12. The signal processing device according to claim 10, further comprising:
a storage unit which stores therein an estimated second signal which is estimated to be contained in said mixed signal,
wherein said restriction unit corrects said estimated second signal in accordance with said background sound signal, and
said suppression unit subtracts said corrected estimated second signal from said mixed signal to restrict said suppression.

13. The signal processing device according to claim 12, further comprising:
a modification unit which modifies said estimated second signal stored in said storage unit
wherein said restriction unit corrects said modified estimated second signal.

14. The signal processing device according to claim 11, further comprising:
a spectral gain generation unit which generates a spectral gain on the basis of said estimated second signal
wherein said suppression unit suppresses said second signal contained in said mixed signal by multiplying said mixed signal by said spectral gain.

15. The signal processing device according to claim 11, further comprising:
a spectral gain generation unit which generates a spectral gain on the basis of said estimated second signal; and
a spectral gain modification unit which modifies said spectral gain in accordance with said background sound signal
wherein said suppression unit suppresses said second signal contained in said mixed signal by multiplying said mixed signal by said spectral gain modified by said spectral gain modification unit.

16. The signal processing device according to claim 10,
wherein said background sound estimation unit does not estimate said background sound in the case where said suppression result outputted by said suppression unit satisfies a predetermined condition.

17. A signal processing method comprising:
receiving a mixed signal in which a first signal and a second signal are contained;
estimating a background sound signal contained in said mixed signal; and
performing suppression of said second signal along with restricting said suppression of said second signal such that an output does not become smaller than said estimated background sound signal.

18. A non-transient machine-readable medium on which a signal processing program is stored, wherein said signal processing program causes a computer to execute processing which comprises;
a receiving step of receiving a mixed signal in which a first signal and a second signal are contained;
a background sound estimation step of estimating a background sound signal contained in said mixed signal; and
a suppression step of performing suppression of said second signal along with restricting said suppression of said second signal such that an output does not become smaller than said estimated background sound signal.

19. A signal processing device comprising:
suppression means for performing suppression of a second signal by processing a mixed signal in which a first signal and said second signal are contained;
background sound estimation means for estimating a background sound signal in said mixed signal; and
restriction means for restricting said suppression of said second signal such that a suppression result outputted by said suppression means does not become smaller than said estimated background sound signal.
